(19) United States
(12) Patent Application Publication
(10) Pub. No.: US 2011/0187664 A1
(43) Pub. Date: Aug. 4, 2011

(54) TABLE COMPUTER SYSTEMS AND METHODS

(76) Inventor: Mark Rinehart, Maryville, MO (US)

(21) Appl. No.: 13/019,185

(22) Filed: Feb. 1, 2011

Related U.S. Application Data
(60) Provisional application No. 61/300,601, filed on Feb. 2, 2010.
(60) Provisional application No. 61/361,737, filed on Jul. 6, 2010.

(51) Int. Cl. G06F 3/041

(52) U.S. Cl. 345/173

(57) ABSTRACT

A table includes: a substantially horizontal table top to be supported at a level suitable for standing or at a level above seats adjacent the table top. The table top includes a substantially horizontally extending touch-sensitive display. The table also includes a computing device in communication with the display to receive touch signals. The computing device defines multiple user areas on the display are oriented to users located/seated at the table top. The table top receives multiple touches on the display essentially or substantially concurrently. The multiple touches provide distinct control signals to the computing device to control operation of the computing device. The table can store instructions for military deployment or military employment. The table can be used for health care environments.

### FIELD OF THE INVENTION

The present inventions relate to table computer systems and methods.

### BACKGROUND

Tables have been the place where people either work independently or more frequently collaborate in groups to share ideas, work, learn, plan, meet, study, socialize, play games and a participate in a number of other activities. For example, students work on projects, employees review documents, businesses make presentations, friends socialize and families play games all around tables. Tables provide the surface to support all sorts of items for people to interact within groups such as drawings, documents, proposals, board games, card games, school projects, restaurant menus, etc.

In today's world technology has become integrated into every part of our everyday lives. People are connected to the internet or to others more than ever before. For example, many people send and receive text messages on cell phones, and others use smart cell phones to access all sorts of internet sites. People use IPods and MP3 players for music, play Wii games for fun and exercise and of course, people interact with computers at work and at home for all sorts of activities and functions.

Certain businesses provide free or low-cost wireless access points to attract more patrons. This has been especially popular for fast food restaurants and coffee shops. The trend to provide people with access to the internet in order to attract patrons seems to have worked as others in the hospitality industry have followed suit. In addition to providing online access to attract patrons, others have added games to keep patrons entertained. For example, some restaurants have added games that allow patrons in their food establishment to play with patrons in other establishments. Bingo is now offered in some restaurants. People purchase a bingo card at a local restaurant and play against others throughout a geographical area. One employee sells cards throughout the restaurant until game time. The employee can then monitor a single computer attached to the internet and call the bingo numbers. When there is a winner, the caller makes an indication of this and notifies a central server. The “bingo” can then be verified. This not only entertains patrons but also generates added revenue for the restaurant.

Consumers also prefer to do whatever they want whenever they want. Consumers have come to expect services that are available 24/7. With the advent of online stores, there is no concept of having to shop during “store hours”. Items can be researched, compared and ordered anytime during the day or night. When a consumer finds what they want, they are able to order it with several key strokes. Arguably, this is not only convenient, but also saves the consumers time. People have come to appreciate instant availability in all types of business including the hospitality industry.

### BRIEF DESCRIPTION OF THE DRAWINGS

FIG. 1 illustrates a schematic view of a location whereat embodiments of the present invention can be used.

FIG. 2 illustrates a side view of a table, according to an example embodiment.

FIG. 3 illustrates a side view of another table, according to an example embodiment.

FIG. 4A illustrates a top view of a table that includes a horizontally positioned touch-screen display, according to an example embodiment.

FIG. 4B illustrates a top view of a table that includes a horizontally positioned touch-screen display, according to an example embodiment.

FIG. 4C illustrates a top view of a table that includes a horizontally positioned touch-screen display, according to an example embodiment.

FIG. 4D illustrates a top view of a table that includes a horizontally positioned touch-screen display with a border area bounding a user area, according to an example embodiment.

FIG. 4E illustrates a top view of a table that includes a horizontally positioned touch-screen display having an application menu area, according to an example embodiment.

FIG. 4F illustrates a top view of a table that includes a horizontally positioned touch-screen display having another application menu area, according to an example embodiment.

FIG. 4G illustrates a top view of a table that includes a horizontally positioned touch-screen display having floating application menu area, according to an example embodiment.

FIG. 4H illustrates a top view a circular application menu area, according to an example embodiment.

FIG. 4I illustrates a top view of a table that includes a touch-screen display having open or common space area, according to an example embodiment.

FIG. 5A illustrates a computer system associated with a table, according to an example embodiment.

FIG. 5B illustrates a computer system associated with a table, according to another example embodiment.

FIG. 5C illustrates a computer system associated with a table, according to yet another example embodiment.

FIG. 6 illustrates a computer system associated with a table, according to an example embodiment.

FIG. 7 illustrates a top view of a table top, according to another example embodiment.

FIG. 8 is a flow chart of a method for displaying information on a Multi-User Social-Interaction Table touch screen display, according to an example embodiment.

FIG. 9 is a flow chart of a method for detecting objects and moving icons underneath an object, according to an example embodiment.

FIG. 10 is a flow chart of a method for detecting objects and moving icons underneath an object, according to an example embodiment.

FIG. 11 is a schematic diagram of a computer readable medium 1100, according to an embodiment.

FIG. 12 is a schematic view of a display, according to an example embodiment.

FIG. 13 is a flow chart of a method for targeting and directing advertisements to a user, according to an example embodiment.

FIG. 14 is a flow chart of a method for providing suggestive selling to a user, according to an example embodiment.

FIG. 15 is a flow chart of a method for activating and deactivating applications at certain times to drive certain of the users actions, according to an example embodiment.

FIG. 16 is a side view of a table having a set of video cameras, according to an example embodiment.

FIG. 17 is a side view of a table having a set of video cameras, according to another example embodiment.

FIG. 18 is a perspective view of a table for use in mobile embodiments of the present invention.

FIG. 19 includes schematic views of various positions of a table, with the interactive portion of the table in various positions.

FIG. 20 is a schematic view of an interactive unit with a healthcare system.

FIG. 21 is a schematic view of a healthcare table, according to an example embodiment.

All Figures are illustrated for ease of explanation of the basic teachings of the present invention only; the extensions of the Figures with respect to number, position, relationship and dimensions of the parts to form the preferred embodiment will be explained or will be within the skill of the art after the following description has been read and understood. Further, the exact dimensions and dimensional proportions to conform to specific force, weight, strength, and similar requirements for various applications will likewise be within the skill of the art after the following description has been read and understood. Where used in various Figures of the drawings, the same numerals designate the same or similar parts.

### DETAILED DESCRIPTION

The Figures generally illustrate exemplary embodiments of the table system for use in a restaurant setting. These illustrated embodiments are not meant to limit the scope of coverage but, instead, to assist in understanding the context of the language used in this specification and in the appended claims. Accordingly, the appended claims may encompass variations of a table system and methods for using the table system that differ from the illustrated embodiments. The table system includes not only a restaurant table but also includes a desk, or a multi-user social-interaction table, or the like.

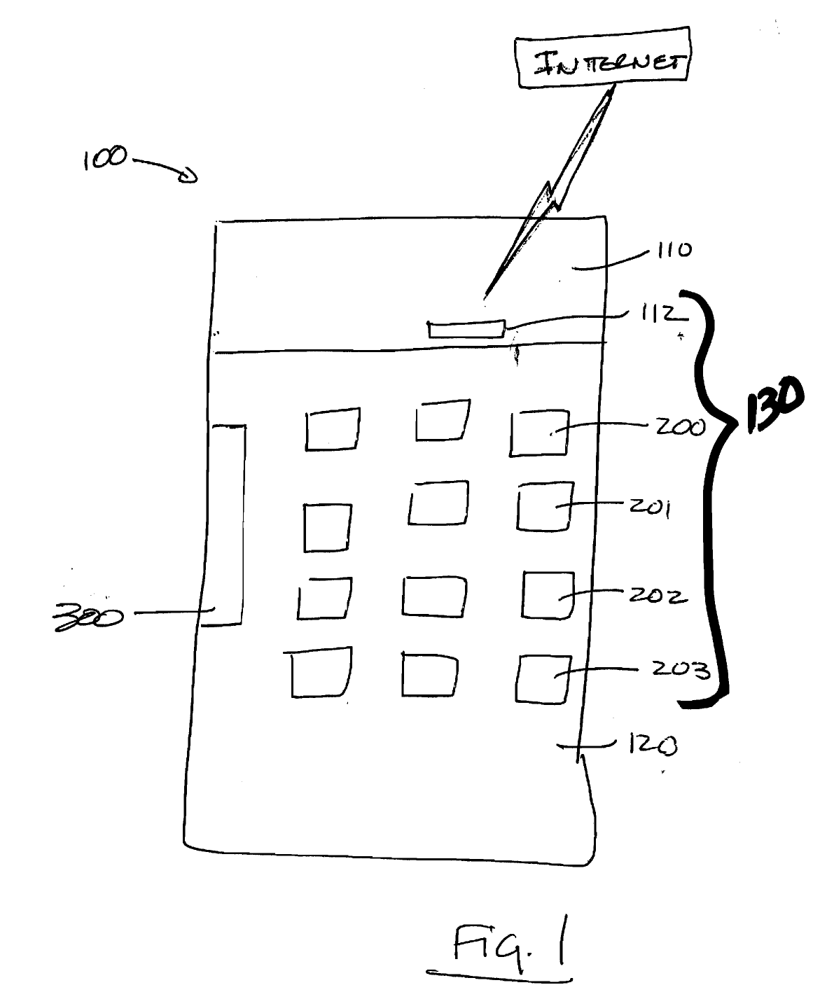

The table system and method could be used in many different environments or in many types of settings. The table can be used in any setting where people gather, wait, study, learn, work, plan, play or socialize. For example, the table could be used in restaurants, coffee shops, bowling alleys, cafeteria's, hotels, airports, bus stations, train stations, government centers, schools, universities and colleges, technical schools, offices, conference rooms, war rooms, hospitals or even doctor's offices. The tables could even be provided on modes of public transportation, such as airplanes, trains, and buses, or the like. The table with integrated computing systems can be used in more unforgiving environments, such as outdoors, research fieldwork, and military environments, such as deployments. The tables described herein can also be used in healthcare field, either as an at home unit, a medical care facility unit, recovery facility unit, nursing home unit, or retirement community unit. FIG. 1 provides one example application of the computing system in a restaurant, but it is contemplated that this system and the methods discussed below could be adapted to any number of different environments.

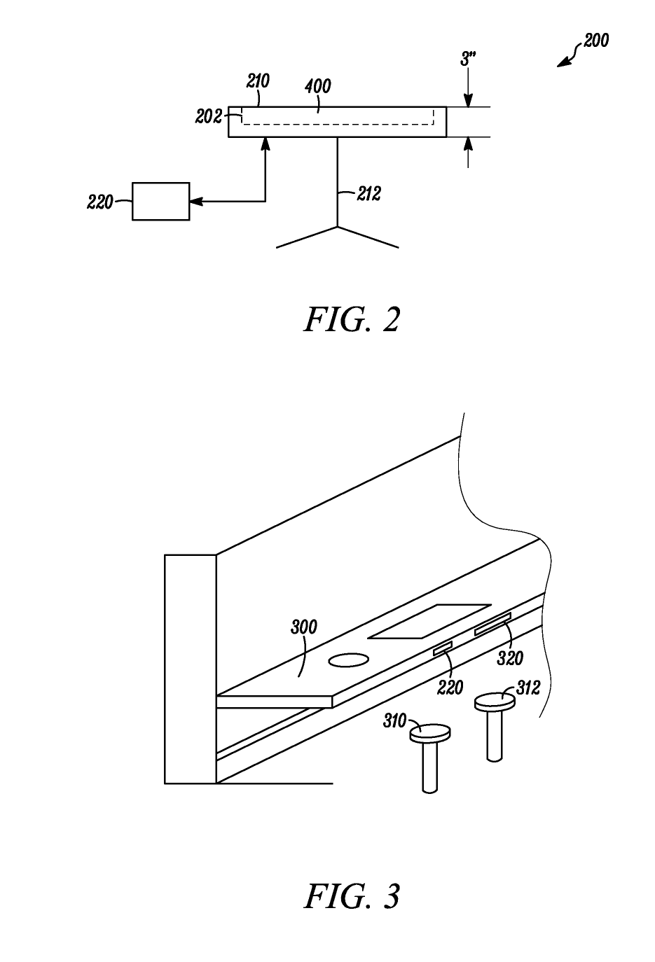

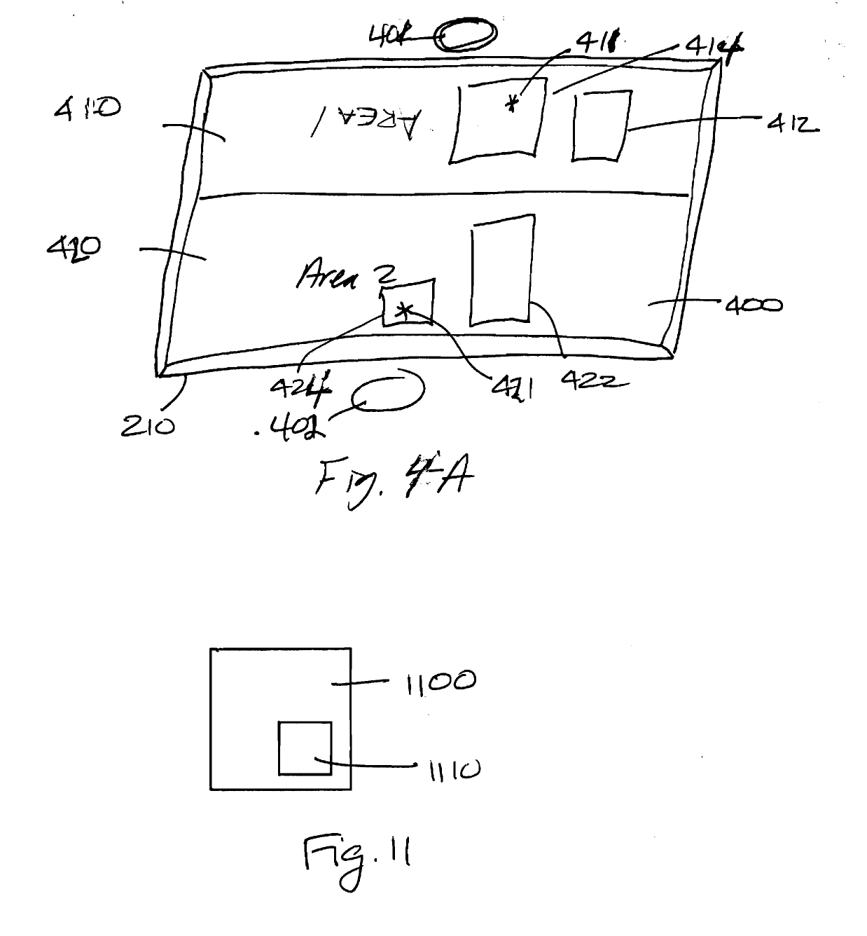

FIG. 1 illustrates a top view of an environment 100, such as a restaurant gathering place, outdoors, or military deployment, which can include a computing system 130 that includes tables, such as tables 200, 201, 202, and 203, a counter 300, and a main computer 112. In an example embodiment, the environment can be a place where people gather and would use data at a table-like structure. In a military environment, the tables 200-203 can be individual tables that are portable and can be used in different functions at any given time, e.g., used to plan and to set up a camp, plan logistics, plan military strategy, communicate and entertain troops, e.g., in the mess hall, etc. The tables 200, 201, 202, 203 all include a touch screen display that is substantially housed within the table. The counter 300 also includes a touch screen display. The displays can have a computing device (shown in FIGS. 2 and 3) associated with each display. The table could be part of a centralized or decentralized computing system. In a decentralized system, the main computer 112 includes a connection to a global computer system, e.g, the Internet. The main computer 112, the computing devices of the tables 200, 201, 202, 203 and the counter top 300 computing device are networked into one or more local area networks or a wide area network. The network can be formed by hardwiring the devices together or via wireless connections. Of course, the network can be formed by a combination of wireless and hardwired connections. The wireless connected computing devices associated with some of the displays in a table allow for flexibility in moving tables together to accommodate larger groups in the restaurant setting. In one embodiment, the restaurant computer 112 is a server for the tables 200, 201, 202, 203 and 300. In another embodiment, the restaurant computer 112 is a point of sale (POS) computer. The POS computer is the computer associated with the checkout location for finally paying the bills in a restaurant.

In another embodiment, the computer system will not have a main computer 112. The tables 200, 201, 202, 203 and counter 300 will have an individual computing device that will serve as personal computers. These individual computing devices will include network cards and will have a wireless connection to a router and firewall combination located in the restaurant. Each device will have a direct connect to the Internet through the router. The tables 200, 201, 202, 203 and the counter top 300 computing device will also be able to integrate into any existing computer system already in a restaurant or hospitality center. The computing devices of the tables and counter can be networked to the existing computer so that order information can be sent to the existing computer in restaurant. It should be noted that even though FIG. 1 shows a top view of a restaurant, the tables can be used in many other environments, such as conference centers, offices, conference rooms, schools and universities, libraries, bars, bowling alleys, coffee shops, museums, waiting areas, and the like.

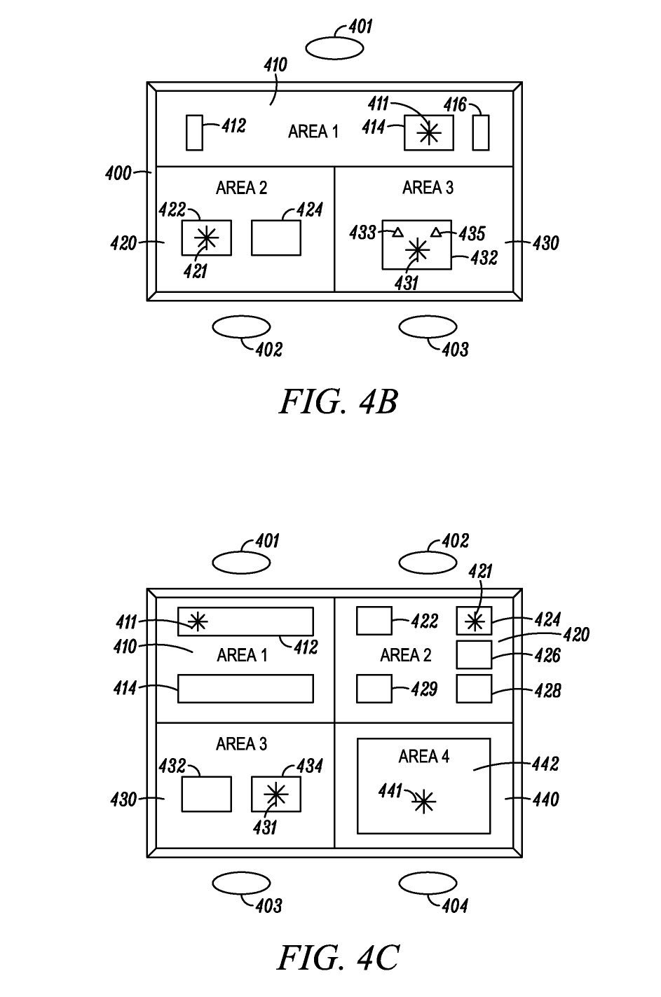

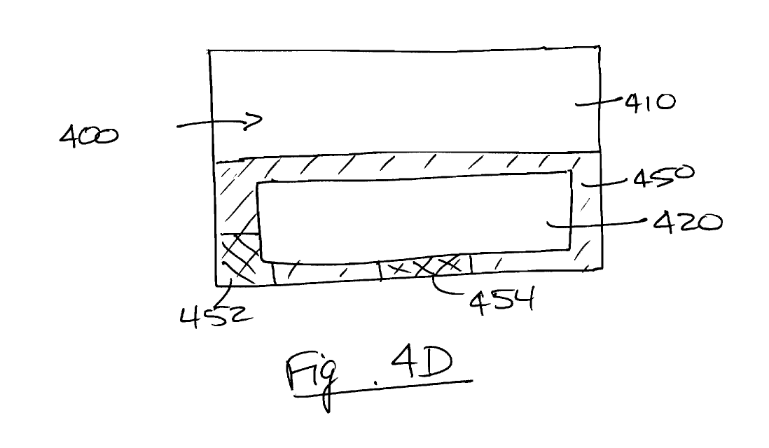

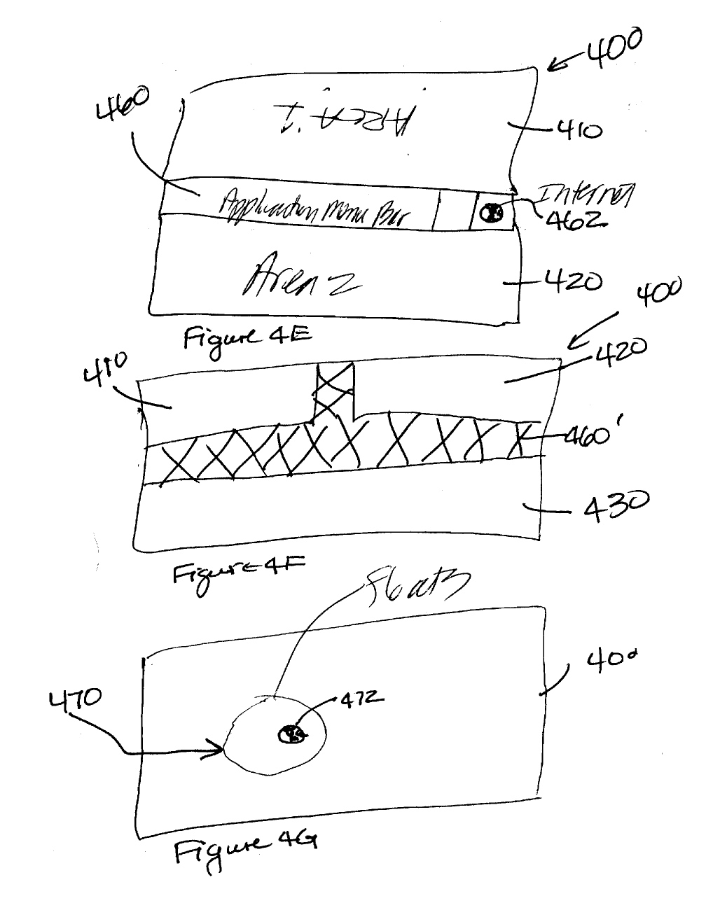

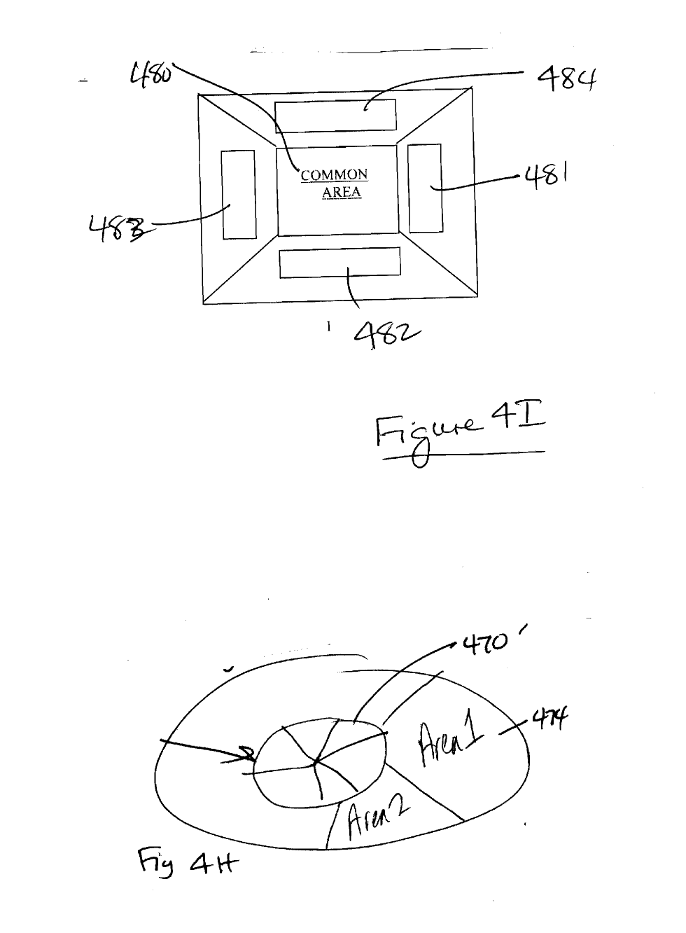

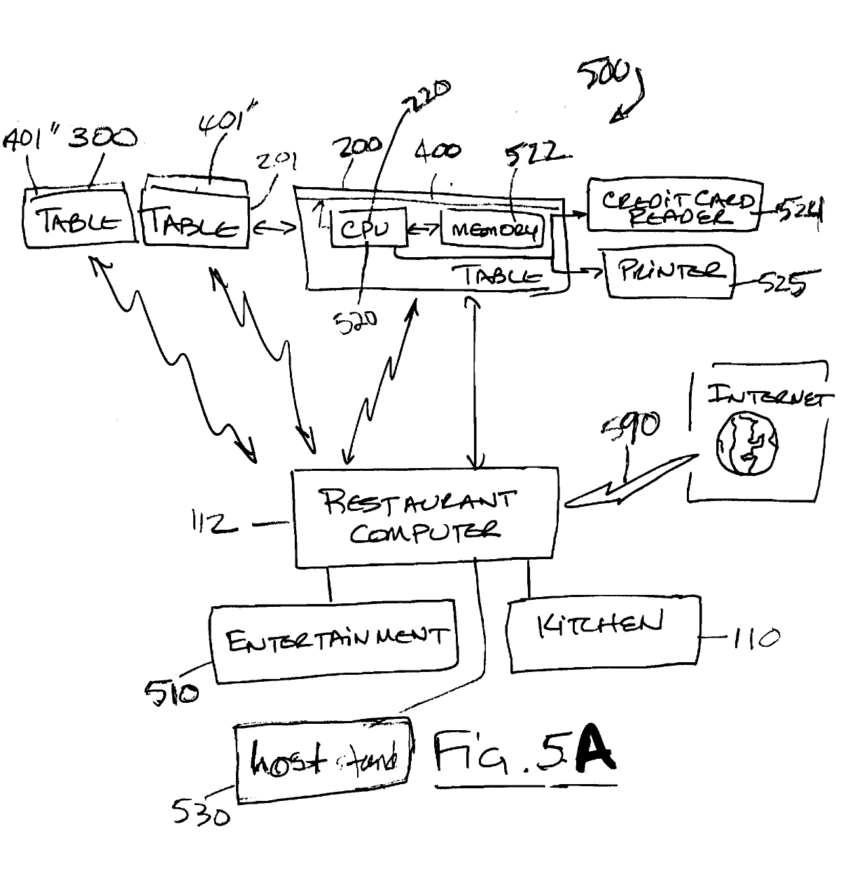

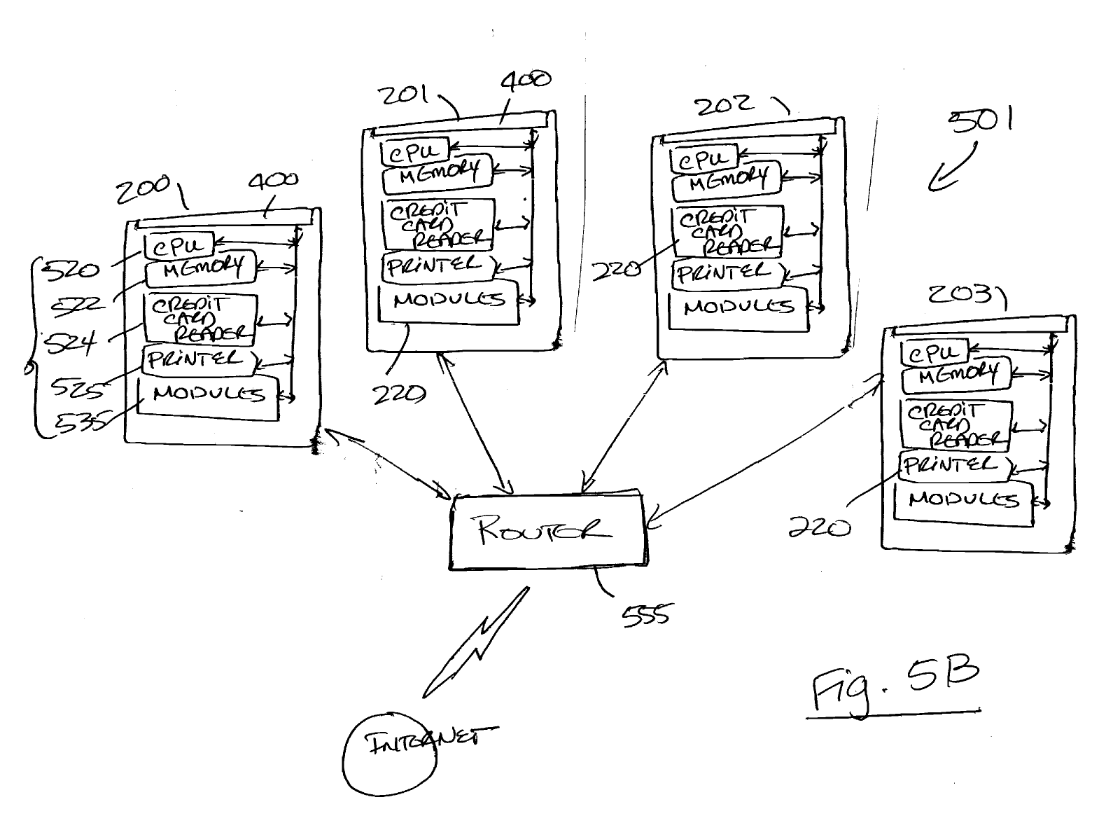

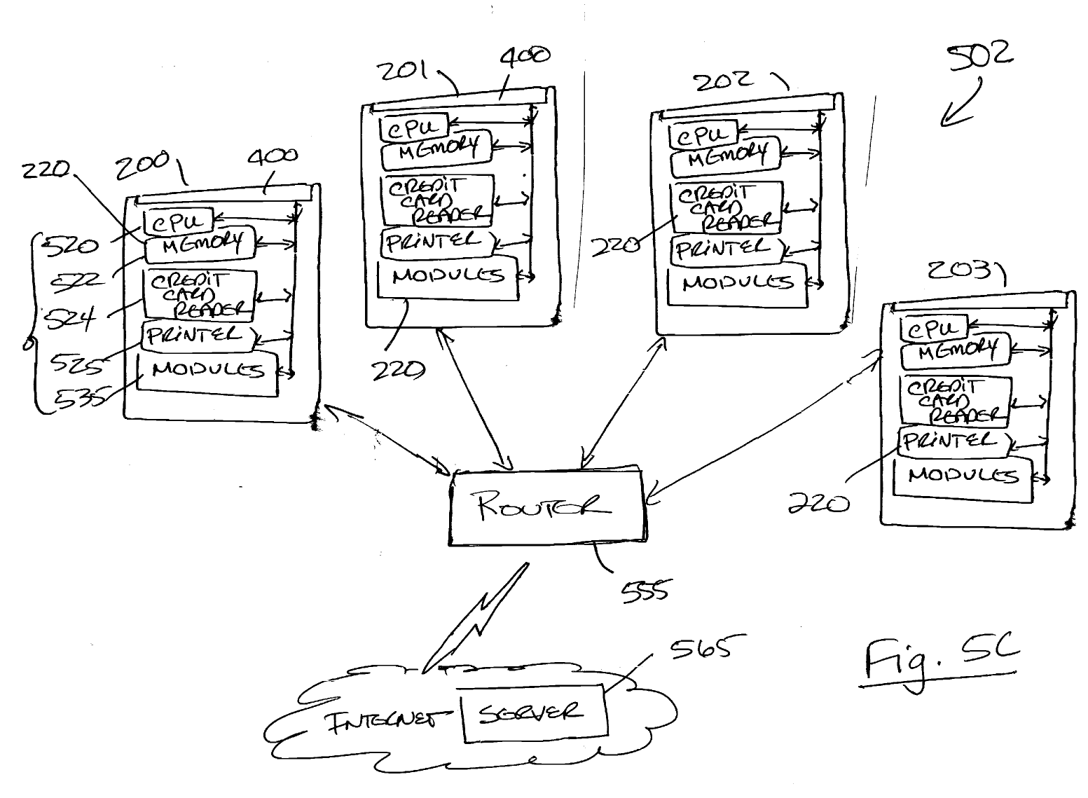

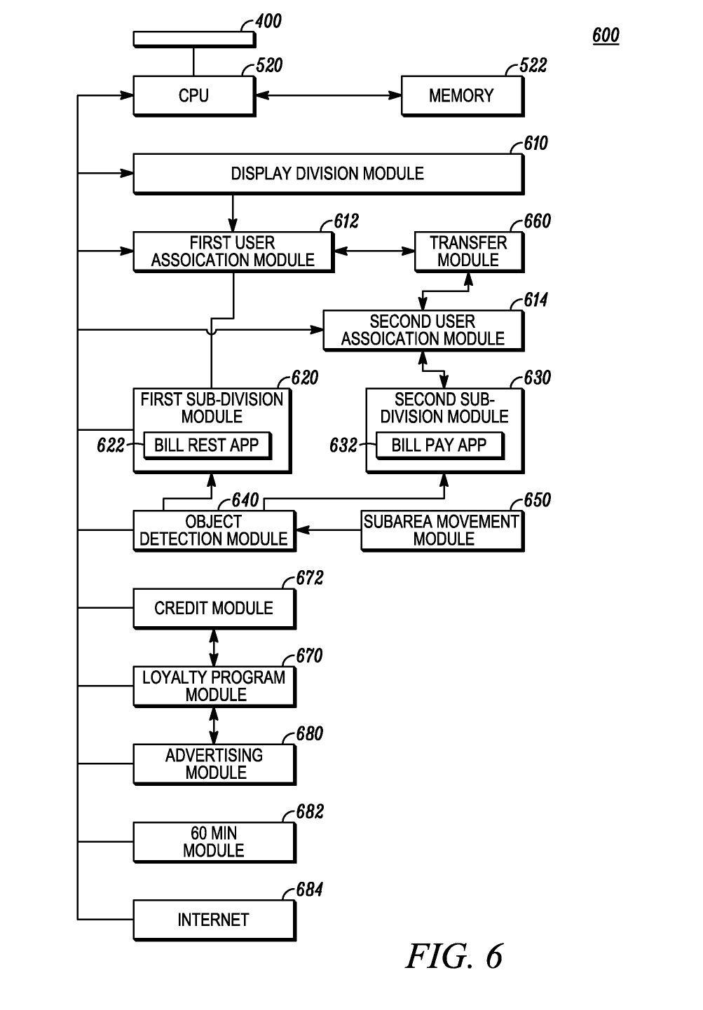

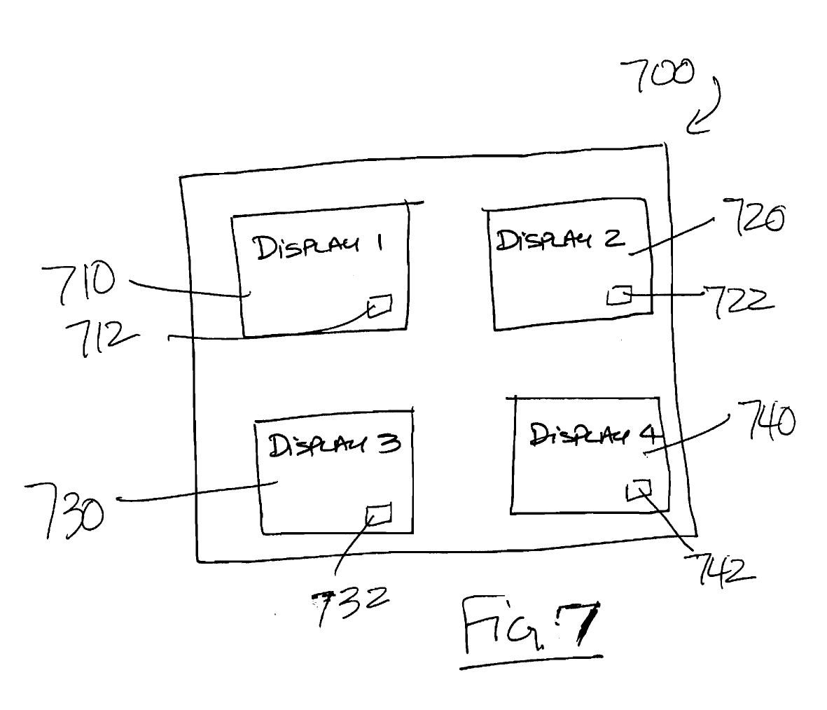

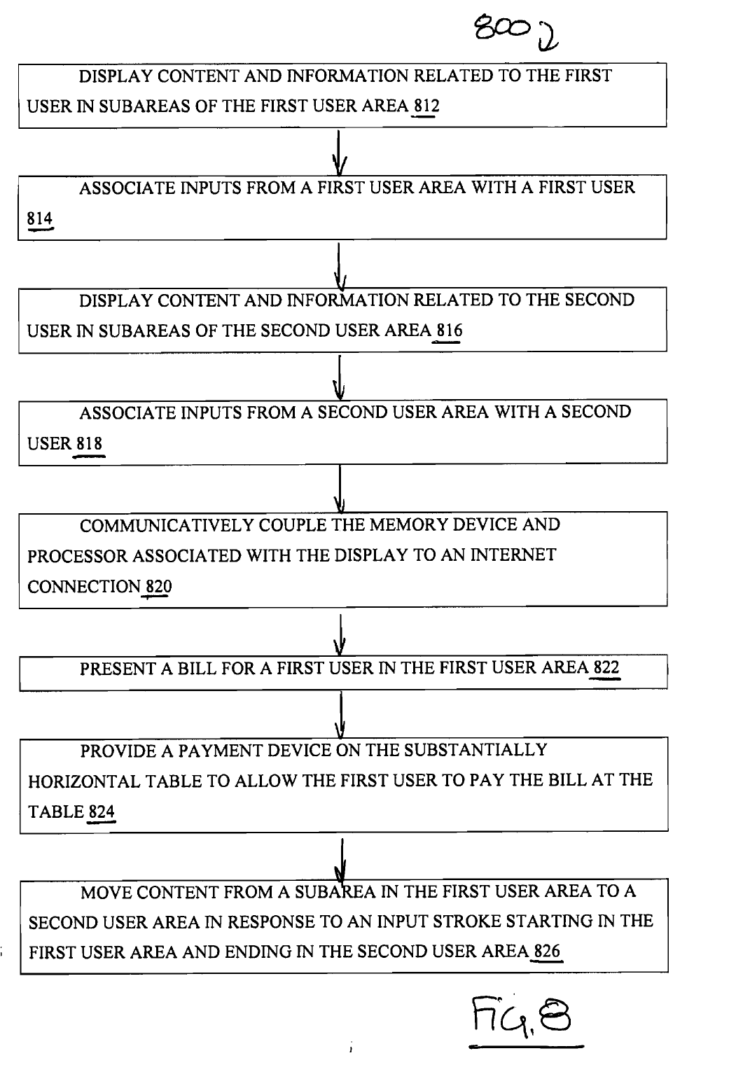

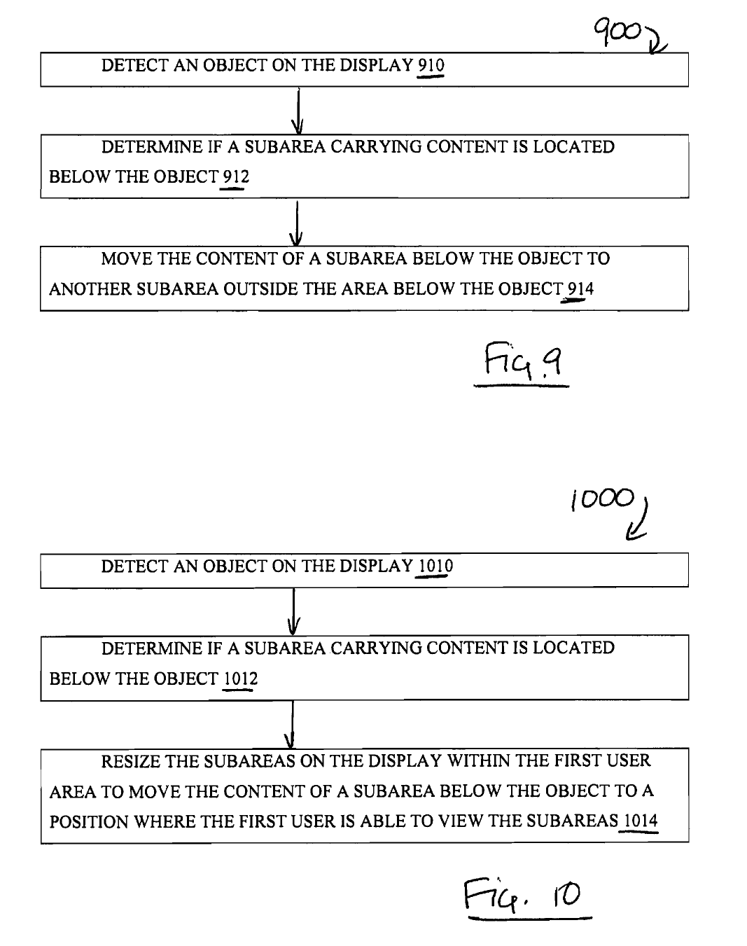

FIG. 2 illustrates a side view of a table 200, according to an example embodiment. The table has a table top 210 attached to a base or pedestal 212. The table top 210 can be a display 400 (further detailed in FIGS. 4A-4C) or can be a housing 202 that carries a display 400. The housing 202 is made from any suitable material including wood, wood veneer, plastic, ceramic, ceramic substitutes, or a combination of suitable materials. Regardless of the configuration, the table top has a thickness of less than or equal to 12 inches. In some embodiments, the thickness is in the range of 2 inches to 7 inches thick plus or minus one inch. In another embodiment, the thickness is approximately in the range of 2.5 to 3.5 inches plus or minus one inch. A computing device 220 includes a microprocessor and memory is attached to the display 400. The computing device 220 can be a stand alone microprocessor capable of performing a wide range of operations or can be a specialized video controller dedicated to performing operations associated with the display 400. Of course, in some embodiments, the computing device can include both a stand alone microprocessor and a dedicated video controller. In such an embodiment, the stand alone microprocessor handles most operations and allows the dedicated video controller handle operations associated with the display. In the embodiments discussed there are no camera based optical, FTIR, or Diffused Illumination systems longer than 12 inches as these prevent the thin dimensions discussed above. Smaller video cameras may be embedded in the display or can be provided as a peripheral outside the display. Of course, the stand alone microprocessor can include a plurality of microprocessors. As shown in FIG. 2, the computing device 220 is located remote from the table top 210. In other embodiments, the computing device 220 is located within the housing 202 of the table top. The display 400 is sealed and otherwise ruggedized so that it can withstand normal wear and tear present in a restaurant, outdoor, military or other similar environment. Advanced filing techniques ensure continued multi-touch performance despite eventual dust, liquids, scratches or other physical wear. The display 400 is available from FlatFrog Laboratories AB of Lund, Sweden as a model FlatFrog Multitouch 4000. The display is available in diagonal sizes ranging from 40 inches to 100 inches.

The table 200 can be positioned at home and can process various health related information. The table 200 can interact with other medical devices that have electro-magnetic communication ability, e.g., wireless, cellular or wired connections. In an example, the table 200 can include various abilities and structures, e.g., U.S. Pat. No. 7,154,397, which is incorporated by reference for any purpose. However, if the subject matter of U.S. Pat. No. 7,154,397 conflicts with the present disclosure, the present disclosure will control interpretation. The table 200 in the at home environment can be used to remind patient's of their healthcare regimen and monitor compliance. Compliance can be reported to the medical care provider. In a further example, the table 200 can include sensing devices to input data regarding the health of a patient. The sensing devices can include a plurality of sensing devices, which can include image sensors, bio-sensors, and audio sensors. The sensing devices can monitor and acquire a user's health related data. The table 200 can include an interaction module. As described herein, the interaction module of the table 200 can divide its touch inputs into a plurality of areas such that a plurality of people can use the same table concurrently. The table 200 can include condition diagnosis module to analyze data. The condition diagnosis module can operate to autonomously analyze the data. If a critical diagnosis is determined, then the table will send an alert or alarm signal to the medical care provider, e.g., physician, and/or other interested individuals, e.g., family member, monitoring service, etc.

FIG. 3 illustrates a perspective view of another table 300, according to an example embodiment. The table 300 is actually a counter or bar. The table 300 includes a display 400 positioned within the counter 300. The display 400 is generally situated between a first seat position 310 and a second seat position 312 at the counter 300 so that a first user in seat position 310 can use one portion of the display and a second user in seat position 312 can use another portion of the display 400. Display 400 can be sized so that could be used in a bar/counter environment. Such smaller displays could still be divided but also can accommodate a single user to using the single display. One such display has a diagonal measure of about 22 inches. Of course, other displays having smaller or larger dimensions can also be used in a bar or counter 300. On a long counter 300 several displays 400 may be placed in the counter 300. Similar to the display 400 shown as a table top in FIG. 2, the display 400 has a computing device 220 positioned within the housing of the counter 300. The display 400 can also have at least one other peripheral device 320 communicatively coupled to the computing device 220 and the display 400 and housed within the housing of the counter 300. For example, the peripheral device 320 can be a printer, a card reader, or even a USB connection to couple other devices to. For example, a person may want to save a receipt for a business expense to a USB memory stick or display documents on the table to share with others. The USB memory stick can be inserted into the peripheral device 320, which in this case is a USB port. The receipt can be saved to the USB memory stick for later use in an expense report. Other uses may include attaching a portable scanner to scan documents discussed and marked up during a business lunch. A scanner could be used to also scan in an invention sketched on the back of a napkin to memorialize the discussion and understanding of the invention. Of course a user could also plug in an iPod or other PDA to download information, such as songs or info from the table. It is contemplated that other connections can be provided to accommodate PDA devices that have different input ports, such as blue-tooth, and the like.

As mentioned previously, there are many applications for the table and it is not limited to the hospitality industry. One example application is for a school, university or college. Another application is the military. The tables could be used as a Multi-User Social-Interaction Table and could be used in classrooms, labs, dorms, lecture halls, or in a student union as discussed above. In another academic application, the table could be used as a lab desk where students learn in groups sharing projects text book information, type notes, and watch videos related to the needed subject matter. Learning could even be done in a collaborative game type environment. In this application, the student could have all materials at his fingertips and yet, still have a clean work area. The table can also be used in filed work, such as excavations, agricultural research, construction research, civil engineering, etc.

In another example, a Multi-User Social-Interaction Table could be used in office environments where people collaborate to review drawings or documents in a group setting, even marking up electronic drawings and making changes. Some corporate centers include gathering places designed to foster collaboration, such as a gathering space by vending machines, in cafeterias, or the like. The same could be said of a surgery team reviewing x-rays, scans and other tests prior to surgery.

FIG. 4A illustrates a top view of a table 200 that includes a horizontally positioned touch-screen display 400, according to an example embodiment. As shown in FIGS. 2 and 4A, the table, such as table 200, 201, 202, or 203, includes: a substantially horizontal table top to be supported at a level above seats adjacent the table top or above the ground or floor. In some applications, the table could be one without seating where people can stand and make decisions. One management technique is for flash meetings, which are called quickly, are short and used to solve problems in a short time. When the table is used in a mobile camp environment, support structures for a traditional computer may not be available until a camp is established, e.g., after the planning and construction phase when a computing device, that includes the multi-touch features of the present invention would be if use. The table top 210 includes a substantially horizontally extending touch-sensitive display 400. The table 200 also includes a computing device 220 in communication with the display 400 to receive touch signals. The touch signals are produced when a user touches a point on the display 400. The computing device 220 defines multiple user areas 410, 420 on the display 400. The multiple user areas 410, 420 are oriented to users seated (e.g. located) at the table top 210. As shown in FIG. 4A, there are two seats 401 and 402. The seat 401 is near the first user area 410 and the seat 402 is near the second user area 420. The table top receives multiple touches on the display 400 essentially or substantially concurrently. The multiple touches are depicted as a first asterisk 411 in the first user area 410 and as a second asterisk 421 in the second user area 420. The multiple touches 411, 421 provide distinct control signals to the computing device 220 to control operation of the computing device 220.

The display 400 is a single, unitary display that may be virtually divided into at least two user areas 410 and 420. The virtually division is based on the number of users that are located/seated at a table. Generally, if more than one user locates/sits at a table the display is virtually divisible into the number of users located/seated at the table. If one user locates/sits down at the table, the interface will not be split into two sections, then full display will be available for the one user to work in. In an embodiment, the users of the table 200 define the virtual division into user areas 410 and 420. For example, the user in position 402 can decide he needs very little space. As a result, the user area could initially be set for half of the display 400, so the user would have virtually half of the table to work. Depending on whether the user is left or right handed, the user could adjust or maneuver the subarea into a position comfortable to interact with. The remaining portion of the display 400 could then be used by the other or first user, in position 401. Of course, the first user in position 401 could decide they also need even less space. The user defines the space needed as well as the position of the user space by entering a command to the computing device 220. In one example, the display prompts the first user to draw a border about the user space 410, such as by touching or forming the area with their fingers, and then dedicates the remaining space to the second user. In another embodiment, the second user is also prompted to draw a border about the second using space 420. In still another embodiment, a default is determined based on the number of users around the table 200. For example, there may be virtual buttons on the display that are pressed after the party is located/seated. When two buttons are touched, the display produces two equally sized user spaces 410 and 420. Regardless of how the screen 400 is divided into the first user area 410 and the second user area 420, the text in each of the user areas 410 and 420 and their related sub areas will be displayed so the user will be able to easily view the information. As represented in FIG. 4A, the text “Area 1” denoting user area 410 is upside down with respect to the text “Area 2” denoting user area 420. Although this specific text probably will not be displayed, the labels illustrate that the text in those areas will be easily readable by the users in positions 401 and 402. In other words, the text in the areas 410 and 420 will be oriented right side up to the user.

The user areas can be further subdivided into a plurality of subareas. As shown in FIG. 4A, the first user area 410 is subdivided into a subarea 412 and a subarea 414. The second user area 420 is subdivided into a subarea 422 and a subarea 424. Of course, a user area can be further subdivided into any number of subareas. At least two of the subareas 412 and 414 of a user area, such as first user area 410, include different content. For example, subarea 414 may include a menu from which the first user can select a menu item and place an order. The users at the table can individually order at least one of food and beverage through respective user areas, and specifically via a menu or drink list presented on the display 400 at a subarea such as 414 or 424. The order can then be sent to a restaurant computer 112 which includes a display in the preparation area 110 of the restaurant 100 (see FIG. 1). The food and or drink are prepared. The order can be delivered to the user that made the order since the position of the user is known by way of the particular user area through which the order was placed. The subarea 414 displaying the menu can also be used for subsequent service requests after the food or beverage is delivered to a particular table. For example, a service needed touch position can be displayed on the menu. Once a service needed area is touched, a listing of possible services could be displayed, such as beverage refill, silverware, or the like that may be needed. In one application, text could be entered to describe “other” services that might be needed. In one embodiment, text would be entered through a virtual keyboard that appears on the display outside of the subarea. The subarea 414 could also be placed in front of the first user so that it is covered while dining. This would prevent the user from having to remove the menu and could become a placemat or the like when a plate of food or a drink napkin and drink are placed on the table top 210.

The area 410, 420 can be assigned to different tasks or users in a military environment. In one area, e.g., 410 can be assigned to an officer charged with the overall layout of a base or temporary site. The other area 412 can be assigned to a logistics officer, who would assigns delivery commands to the appropriate sources and delivery locations for the needed supplies. The areas and subareas can further be assigned to various needs of the base or camp, e.g., security, utilities, medical, housing, etc.

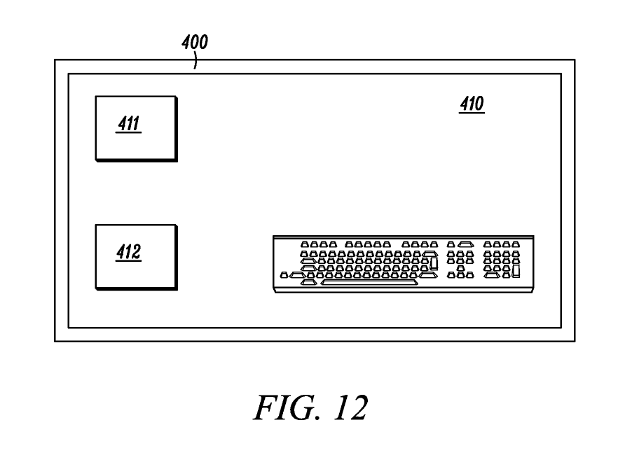

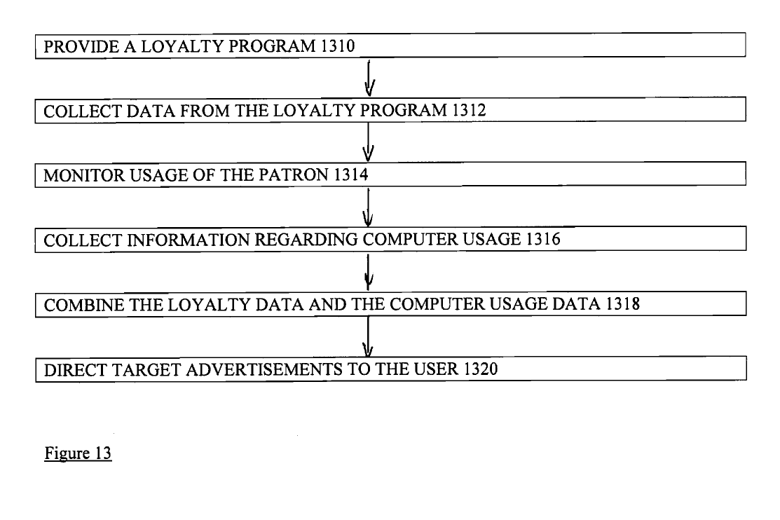

A display 400 that includes a virtual keyboard is shown in FIG. 12. The virtual keyboard is actually a set of keyboards 1210, 1220, 1230, and 1240. One of the keyboards 1210, 1220, 1230, and 1240 is selected for input. This accommodates users that are used to different keyboards or keyboards associated with different languages. It is also contemplated that the various keyboards could include virtual keypads, such as from an adding machine, and other virtual input devices. These various keyboards could be made available and selected by the user. As shown, in FIG. 12, several keyboards are presented one behind the other in a series of stacked windows. The user selects the desired keyboard, which is then displayed on top of the stack. A set of virtual keyboards is available from the Comfort Software Group of Vancouver, British Columbia, Canada. Other virtual keyboards could also be used. Although only one user area 410 is shown in FIG. 12, it is contemplated that each user area on a table would be provided with a set of keyboards 1210, 1220, 1230, and 1240. For example, if screen 400 is divided into four user areas 410, 420, 430, 440, it is contemplated that each of the user areas 410, 420, 430 and 440 would be provided with a set of keyboards so that the user can select a virtual input device for his or her user area. Different users can select different keyboards and the different keyboards can be used substantially simultaneously by different users at a table. The user can also change the type of input device during use. It is also contemplated that the user could even have two input devices open in one user area. For example, an accountant may want to type a letter after using a virtual adding machine type keyboard. The accountant may have both a virtual QWERTY keyboard, and a virtual adding machine virtual keyboard open at the same time in his or her user area.

In another embodiment, one keyboard is provided and others are made available as icons in a space not used as a keyboard, such as above the top of the keyboard. The icons represent other types of keyboards or input devices. Changing the configuration of the keyboard includes merely clicking on an icon for the new input device. Of course, the previously selected input device is replaced with an associated icon when the newly selected input device is displayed.

At the conclusion of the visit, the first user and the second user can pay for the visit at the table 200. The table 200 or 300 includes a card reader, such as card reader 320. The card reader 320 can be used to identify a user. In another embodiment, a credit card can be swiped in the card reader 320, which magnetically reads the credit card account information. In the alternative, the first user or the second user can enter the card number and other credit card information via the display and a keypad. The keypad could be provided via the display 400. In another embodiment, a virtual keypad would appear on the display 400 to allow for user input using a series of touches on various keys of the virtual keypad. A card reader, such as card reader 320 could be used to identify a customer for a loyalty program. In the alternative, the customer could be provided with a card that includes an RFID (Radio Frequency IDentification) tag. Of course, any number of short range communication devices or technologies could be used to identify and provide for communications with the user. One such communication device would be a Bluetooth channel. Devices, such as a user's cell phone, could be linked to and the table as well as to a loyalty program. The person's phone number or MAC address would be the identification number used in loyalty programs or used as the key to data already stored on a restaurant or hospitality system server. This would be the user's “card” and would be one less card to produce, and would be one less card for the user to carry. With an RFID tag, the customer could be identified by a reader when he or she enters the establishment. The customer could also be identified at the table for a loyalty program or the like. Depending on the loyalty level, selected perks could be provided to the customer, such as preferential seating and the like.

The subareas 412, 414, 422, 424 can carry all types of content and programming and are not limited to a restaurant application used to order. It is anticipated that the subareas 412, 414, 422, 424 could also include content and programming via an internet connection. For example, programming such as social networking applications like LinkedIn, Facebook, Twitter or the like could be checked and monitored during the wait for food and drink. Games such as games played against others could be played while the people wait for food and drink. Entertaining content (television, video, or audio) could also be provided, or business documents could be brought up, reviewed and amended during a discussion over a meal or drinks The possibilities are limitless. Musical games, such as Karaoke, could be provided. In addition to social networking to other people outside the hospitality venue, applications are contemplated that provide a social networking environment within the hospitality environment. For example, certain patrons may communicate with other patrons for various games or on various topics. Other patrons might decide to send messages, images, or other information to other tables within the venue. The participation in games could be over the network associated with the hospitality venue, such as the restaurant so that patrons within the restaurant could be playing against one another to determine a restaurant champion. Social networking could also be provided within the restaurant. Social networks such as twitter could be used for social networking with willing participants indicating that they are in the restaurant. Other content could be provided and sold to users to generate extra income for the restaurant or hospitality venue as well as entertain the patrons. The subareas 412, 414 associated with user area 410 would be oriented so that a used at position 401 could read the content right side up. Similarly, subareas 432, 434 would be oriented so that a user in position 403 could read the content as right side up. Because these two positions are across the table from one another, the content in the subareas would be oriented in two different directions.

It is also contemplated that users at one table in a hospitality venue could move information from a first table to another table within the hospitality venue. For example, in a conference setting, content could be shared amongst several tables in a conference center. At the same time, people at the conference could be exchanging contact information of even information about activities outside the conference schedule. Conferees could set dinner times for entertainment purposes or the like. A search could even be done of the participants and sponsors in attendance. The search could be for people a salesman would want to attempt to meet face to face for example while at the conference. In a restaurant, an insurance salesman could send a quote to another patron of the restaurant or share information and images on a recent fishing trip or the like. The possibilities are endless.

In some embodiments, an output device, such as peripheral 320, is in communication with the computing device 220 associated with the table top 210 or the counter 300. One such output device includes a printer that is associated with the housing 202 of the table top 210. A patron could print up a bill or invoice to turn in for an expense account or print a different coupons or promotional ads. The printer could also be used to provide a hard copy of a document. In still another embodiment, a printer could be networked to a remote printer, or could be attached to restaurant computer 112 or to an existing Point of Sale (“POS”) printer associated with an already existing computer system. In yet another embodiment, the bill could be forwarded to an E-mail account of the user. The user can then access the E-mail later and print the bill out as needed or store it with similar documents.

In one embodiment, documents or other content could be transferred by way of a transfer module 660 (see FIG. 6). The transfer module is a combination of hardware and software used by the computing device to transfer content and programs between different user areas based on a touch in a source subarea of the display. For example a document in a second user area can be moved to a first user area using a stroke passing from the first user area and terminating in the second user area. To move a document from a first user area to a second user area, the document is touched and then dragged to the second user area where it is dropped. The document then becomes the second users. The second user can E-mail or save it to a memory stick or the like.

When the display is virtually divided into a first user area and a second user area, an input placed into a first user areas is associated with a first user, and an input placed into a second user area is associated with a second user. Inputs into a first user area and inputs into a second user area can be received substantially concurrently. In addition, multiple touches in the first area can be handled. Furthermore, multiple touches in the first area and multiple touches in a second user area can also be processed or handled.

FIG. 4B illustrates a top view of a table 200 that includes a horizontally positioned touch-screen display 400, according to an example embodiment. The table 200 shown in FIG. 4B is substantially the same as the table shown in FIG. 4A and operates in substantially the same manner. Rather than describe the entire touch screen 400 and its operation, the difference between the touch screen 400 of FIG. 4A and the touch screen 400 shown in FIG. 4B will be described. The difference is that there are three users of the table 200 shown in FIG. 4B. The three users each have a user area, resulting in a first user area 410, a second user area 420, and a third user area 430. The first user area includes three subareas 412, 414, and 416. The second user area includes two subareas 422, 424. The third user area includes a single sub area 432. Each of the areas includes a touch depicted by an asterisk. The touch 411 is located in subarea 414, the touch 421 is located in sub area 422, and the touch 321 is located in subarea 432. The touches are associated with the various users by use of their respective areas. In addition, these touches 411, 421, 431 can be substantially concurrent. Triangles 433 and 435 depict touches at another time, such as time t₂. The triangles 433 and 435 depict two substantially simultaneous touches that occur at the time t₂. In other words, multiple touches can be placed in sub area 430 or any sub area at substantially the same time. The microprocessor and any video controller can determine the separate inputs associated with the two substantially simultaneous touches 433, 435 in the single sub area 430. The user areas 410, 420, and 430 are generally positioned near the seat positions 401, 402 and 403 of the various users.

FIG. 4C illustrates a top view of a table 200 that includes a horizontally positioned touch-screen display 400, according to an example embodiment. The table 200 shown in FIG. 4C is substantially the same as the table shown in FIGS. 4A and 4B and operates in substantially the same manner. Rather than describe the entire touch screen 400 and its operation, the difference between the touch screen 400 of FIGS. 4A and 4B the touch screen 400 shown in FIG. 4C will be described. The difference is that there are four users of the table 200 shown in FIG. 4C. The four users each have a user area, resulting in a first user area 410, a second user area 420, a third user area 430, and a fourth user area 440. The four users are located at positions 401, 402, 403, and 404 around the table 400. The first user area 410 includes four subareas 412, 414, 416 and 418. The second user area 420 includes five subareas 422, 424, 426, 428, 429. The third user area 430 includes two subareas 432 and 434. The fourth user area 440 includes a single sub area 432. Each of the areas includes a touch depicted by an asterisk. The touch 411 is located in subarea 412, the touch 421 is located in sub area 424, and the touch 321 is located in subarea 434, and the touch 441 is located in subarea 412. The touches are associated with the various users by their occurrence within the bounds of their respective user areas. In addition, these touches 411, 421, 431, 441 can be substantially concurrent. It should be noted that multiple touches in one area can also be processed as well as multiple touches in another user area. The multiple touches can come in the form of touches or multiple touches in the various user subareas.

The various FIGS. 4A, 4B and 4C show different configurations of user areas on a touch screen display 400. The user areas that are formed can be of different sizes. In addition, the subareas within the user areas can also be formed as different sizes. The size of the areas and subareas can be defined by the user. The number of subareas is also defined by the user. The user sizes the subareas or resizes the subareas using touch commands. The subareas generally appear when a user elects to run an additional program, such as opening an additional internet connection. The inputs or touches on the touch screen 400 are mapped to the user area and the subarea to determine the commands and their source. The computing device 220 is capable of handling the video portion as well as interpreting commands so that touches can be occurring on the touch screen 400 substantially simultaneously.

FIG. 4D illustrates a top view of a table 200 that includes a horizontally positioned touch-screen display 400, according to an example embodiment. In this particular embodiment, the screen display 400 is provided with a border space 450 around the area of the screen display, such as user area 420 shown in FIG. 4D. The border space 450 could be populated with advertisements 452, 454, within the border space. The border space 450 is designated with hatching. The advertisements 452, 454 are designated with cross hatching. It is contemplated that the advertisements 452, 454 could totally populate the border space 450 around the user area 420. The advertisements could simply be sponsors that pay to display advertisements to all patrons. The advertisements could also be targeted to the customer or particular user. For example, by tracking the content to which the user at a particular user area is accessing, the ads can be targeted to the user. In addition, the advertisements could change in response to the content being accessed within the sub area 420 or based on both the current content being accessed and a history of the content previously accessed by the user. Demographic data from a loyalty program or other data can also be used to help target advertising. In addition, a combination of sources can be used to target the advertisements 452, 454. It is also contemplated that a border could be provided around each user area designated at a table. The border space 450 need not bound all sides as shown.

FIG. 4E illustrates a top view of a table 200 that includes a horizontally positioned touch-screen display 400, according to yet another example embodiment. In this particular embodiment, the screen display 400 is provided with an application menu bar space 460 on an area of the screen display that is located between a first user area 410 and a second user area. The application menu bar space 460 could be populated with icons 462 associated with applications the various users could select. For example, one could connect to the internet via by touching on an icon and dragging it into their particular user space 410 or 420. This would open a user subarea with the text orientated so that they could easily read the text. Other applications might be games, word processing programs, spreadsheet programs, social networking websites, and the like. The application menu bar space 460 is not limited to the area between user areas, as will be shown below.

FIG. 4F shows an application menu bar 460′ located between areas, according to another example embodiment. Again, the application space 460′ is not limited to the area between user areas, as will be shown below. The space 460′ can provide a list of computer applications and tasks that can be used on the table.

FIG. 4G illustrates a top view of a horizontally positioned touch-screen display 400, according to yet another example embodiment. In this particular embodiment, the screen display 400 is provided with an application menu space 470 on an area of the screen display that floats over the various user areas. The application menu space 470 is circular and can be populated with icons 472 associated with applications the various users could select. Although only one icon is shown, it is contemplated that a plurality of icons could be provided in the floating application menu area 470.

FIG. 4H shows one possible display for the floating application menu space 470. The application menu space would be divided into two substantially concentric circles. The inner area would be the application menu space 470′ and the outer area or ring would be an area designation space 474. The icons in the space 470′ could be rotated using a finger stroke. The application icons could then rotate to a position near the user area designation space 474. In operation, the applications would be on a “lazy Susan” and could be rotated and dragged to the area of the user or another user by dragging the application to a user designation area 474. For example, if the user of area 2 wanted to show a user of user area 1 how to sum numbers in a column in a spreadsheet application, the initial step would be to open the application in the other person's user area. Once the application is dragged onto the user area designation space, the application opens in the designated user's actual user area.

FIG. 4I shows another possible display, according to an example embodiment.

The display 480 shown in FIG. 4I features several user areas 481, 482, 483, 484 and a common area 480. The common area can display anything that all users of the several user areas 481, 482, 483, 484 are supposed to see. For example, in a gaming situation, the common area might show cards played or selected cards that are face down and face up. The face-up cards are displayed. The face-down cards are also displayed until they are “turned over” for display. Another use for the common area would be for programs or applications that anyone could use or grab for use in a user area. It should also be noted that the areas can be split in different ways. It is contemplated that user areas could also be designated in free forms other than straight line edges.

FIG. 5A illustrates a computer system 500 associated with an environment 100 (shown in FIG. 1), e.g., a restaurant, according to an example embodiment. The computer system 500 is a network of computers 112 and displays that also having computing devices, such as computing device 220 and which also include a connection to a global computer system, e.g., the internet 590. Table 200 details the computing device 220. Computing device 220 includes a microprocessor or CPU 520 and a memory 522. The CPU is communicatively coupled to a credit card reader 524 and a printer 525 and a display 400. The CPU can include a single microprocessor or a plurality of microprocessors and controllers. The computing device 220 is associated with a table 200 featuring a substantially horizontally positioned touch screen 400 that users can divide into user areas and further subdivide into subareas. The computing device 220 of the table 200 is coupled to the restaurant computer 112. As shown, the link between the computing device 220 and the restaurant computer 112 can be hardwired, wireless, or both. The restaurant computer system 500 is also connected to table 201 and table 300, each of which include a configuration of a computing device similar to the computing device 220 shown in table 200. The tables 201 and 300 also include substantially horizontally positioned touch screen displays 401 and 401. In an example of the restaurant, the computing system 500 also includes various displays such as to the food and drink preparation area 110 and to a host or hostess stand 530 that could receive payment for food and drink bills should the patron elect not to pay at the table. For example, the patron may elect to pay in cash rather than to use a credit or debit card. The main (e.g., restaurant) computer 112 is also coupled to an entertainment device 510. The entertainment device 510, in one embodiment, is a server that includes video such as movies or cartoons, and games played in the restaurant environment. The entertainment device 510 could be used to generate additional revenue, such as by pay for view of a video, or pay to play games. In another embodiment, the entertainment device could be connected to other establishments so games could be played against patrons of other restaurants or bars. The entertainment device 510 could also provide musical entertainment, such as a karaoke application that can be placed on the tabletop 210 of a table, such as table 200. In another embodiment, separate entertainment devices or restaurant computers are not needed. In this embodiment, individual modules are installed on each local computing device associated with a table. The computing device can be a personal computer (“PC”) which is positioned within the housing of the table or which is remote from the table, and would like to be able to integrate into a PC at the host stand or POS computer.

The main, restaurant computer 112 could also be used to provide a customer loyalty program for various patrons that use the computer. A side benefit of such a program would be the gathering of data as to the patron's computer usage while in the restaurant. This information could be used to send targeted advertisements to the user while in the restaurant. In addition, targeted advertising could be sent to the customers E-mail address based on information gathered from the user while in the restaurant. The use of the table, which includes the touches and activities selected by the user while at the table is tracked as information that can be used later for various reasons, including targeting advertisements to the user as well as selling the data to other parties. The user loyalty program could not only provide credits for purchase actions, but could also provide credits for other non purchase actions. For example, participating in a survey could be awarded a certain level of loyalty points or entertainment credits.

FIG. 5B illustrates another embodiment of a restaurant computer system 501 associated with an environment 100 (shown in FIG. 1). The computer system 501 is a network of computers and having displays 400, which are housed within tables 200, 201, 202, and 203. The tables 200, 201, 202, and 203 could also be termed Multi-User Social-Interaction Tables 200, 201, 202, and 203. Each of the tables includes a computing device 220 such that each is a stand alone computer. Thus, each of the tables 200, 201, 202 and 203 can also be termed a computer. A computing device 220 includes a microprocessor or CPU 520 and a memory 522. In one embodiment, the CPU can be communicatively coupled to a card reader 524 and a printer 525 and the display 400. The CPU can include a single microprocessor or a plurality of microprocessors and controllers. The display 400 shown in FIG. 5B is a substantially horizontally positioned touch screen 400 that users can divide into user areas and further subdivide into subareas. The computing device 220 of a plurality of the tables, such as table 200 and table 201 are networked and either hardwired or wirelessly connected to a router 555 which in turn is coupled to a computer network, e.g., intranet or the internet. In one embodiment, a majority of the tables or counters or other hospitality devices that include a computing device 220 are networked together and communicatively coupled to the router 555. Each of the computing devices includes various modules 535 for various functions. For example, a computing device may include an entertainment module that would allow the computing device to provide video and audio entertainment either from storage at the computing device or by way of an internet connection. Planning module can launch processes for planning a deployment or development of a camp or other military processes. A loyalty program module could track dollars spent by the patron or another method for points, in a restaurant or commercial environment. Another module could provide a menu for payment and handle the payment for goods and services as well as other menu items. The modules 535 will be further discussed and detailed below.

FIG. 5C illustrates another embodiment of a restaurant computer system 502 associated with the environment 100 (shown in FIG. 1). The computer system 502 is a network of computers and having displays 400, which are housed within tables 200, 201, 202, and 203. Each of the tables includes a computing device 221 such that each is a stand alone computer. Thus, each of the tables 200, 201, 202 and 203 can also be termed a computer. A computing device 220 includes a microprocessor or CPU 520 and a memory 522. In one embodiment, the CPU is communicatively coupled to a credit card reader 524 and a printer 525 and the display 400. The CPU can include a single microprocessor or a plurality of microprocessors and controllers. The display 400 shown in FIG. 5B is a substantially horizontally positioned touch screen 400 that patrons can divide into user areas and further subdivide into subareas. The computing device 220 of a plurality of the Multi-User Social-Interaction Tables or tables, such as table 200 and table 201 are networked and either hardwired or wirelessly connected to a router 555 which in turn is coupled to the internet. A remote or offsite server 565 is also coupled to the network via the internet or intranet. The remote or offsite server 565 can provide various services to the individual tables in substantially real time. The remote or offsite server 565 can also provide services to several different hospitality venues, such as multiple restaurants, airport waiting areas, hospital waiting areas, and the like. In one embodiment, the remote server 565 may be a virtual server in a cloud computing environment.

FIG. 6 illustrates a view of a computing device or computer system 600 associated with a table 200, 201, 202, 203, and 300, according to an example embodiment. The computing device includes a processor 520, and a memory device 522 communicatively coupled to the processor 520. A touch screen display 400 is also communicatively coupled to the processor 520. The computing device or computer system 600 includes a display division module 610 for dividing a display into at least a first user defined area and a second user defined area. The computer system 600 also includes a first user association module 612 and a second user association module 614. The first user association module 612 associates inputs from a first user area with a first user and associates content and information selected for display by the first user with the first user. The second user association module 614 associates inputs from a second user area with a second user and associates content and information selected for display by the second user with the second user. The display division module 610 divides the display into a first user area and a second user area based on input from at least the first user. The computer system also includes a subdivision module for subdividing a user area into subareas. As shown in FIG. 6, the computer system 600 includes a first subdivision module 620 for subdividing the first user area and a second subdivision module 630 for subdividing a second user area. The subdivision module 610 can subdivide the table into any number of user areas based on total number of users at the table. The computer system 600 displays information and content associated with a user in the subareas. At least one of the subareas includes an interface to an application 622 for presenting a menu of options, and a bill for at least a first user. One application can be directed to a restaurant. The restaurant application 622 is found in one of the subareas. As shown in FIG. 6, there is also a restaurant application 632 in the second subdivision module 630. The menu of options need not be directed to food or drink but could be directed to other activities. For example, in one application the options presented on the menu could be gaming options or gaming activities. Other activities could also be displayed and paid for through a menu application.

The menu is not limited to food items and will reflect the services that are available in the specific hospitality environment in which the table and the system of tables are placed. For example, if the table is placed in an arcade, the menu presented would include one or more games that could be played at the table or remote from the table. For example, reservations for a game remote from the table could be reserved at the table. When the reservation time is near, a reminder could be sent to the user or users at the table to move to the remote area to play the game. Other entertainment choices could also be selected or ordered at the table, such as movies, or other content. One could also reserve a Karaoke machine or to have entertainers show up to sing at the table, for example. These embodiments can also be adapted to military uses and environments.

The computer system 600 also includes an object detection module 640 for detecting an object on the touch screen display and determining if a subarea carrying content is located below the object. The computer system also includes a subarea movement module 650 for moving a subarea below the object to a portion of the first user area viewable by the first user. Of course, the user could merely drag the subarea or subareas that may wind up under a plate to a portion of the user area visible after a meal is delivered. The object detection module 640 can also detect certain objects, shapes or gestures which in turned trigger other events. For example, once a meal is served and the object detection module 640 detects plates on the table. A timer could be started to delay a certain action by the computing device. For example, upon detection of a large plate being added to the table, the timer would be set. At the conclusion of a selected time, the computing device could present the user or users with a desert menu or merely float an image of a desert on the screen. The computer system also includes a bill paying module 622, 632 located at the table.

The computer system 600 also includes a loyalty program module 670 which monitors various expenditures and awards loyalty points to the user. The loyalty program module can include a credit module 672. The credit module 672 would add credits for various actions. For example, the amount of a bill could be used to generate entertainment credits which could be added to an account of “entertainment credits” for a user. Entertainment credits could be used to purchase other forms of entertainment or for discounts on future bills. In response to swiping a credit card, a dollar amount could be picked, and then added to the account of the user that will receive those credits. One use of the entertainment credits could be to allow the user to gain Internet access or for playing games. The computer system also includes a content moving and transfer module 660 for moving content from a subarea in the first user area to a second user area in response to an input stroke starting in the first user area and ending in the second user area.

The computer system 600 also includes an advertising module 680. The advertising module 680 can monitor user's particular purchases and the particular user's interests and use this information to target advertisements to be selectively placed in the user area of the particular user. All or part of the data associated with any user's inputs can be monitored and saved for future analysis. The data regarding the user's inputs can be stored in memory and could also be used to determine bills for either touches to various advertisements or impressions. Impressions could also be enhanced by measuring an amount of time the customer reviewed an advertisement. The data could also be collected and sold to others for use in targeting users in other venues. The data collected could include not only what is purchased during a visit to a restaurant but a listing of the internet sites visited while there. The internet sites could also be further broken down into web pages browsed to give a further set of interests. The loyalty program generally will include further demographics as well as credit card types used and other information. The hospitality venue or restaurant could sell this data to further increase profits at the restaurant or to use in their marketing efforts. The advertising module 680 could also be used to time the placement of advertisements. For example, at a selected time after an event, high margin desserts could be advertised to the patron or a menu of dessert items and after dinner drinks could be provided to the user area. In another embodiment, the advertising module 680 could merely run a set of advertisements on a round robin basis. FIG. 6 also includes an internet module 684 and a gaming module 682. The gaming module 682 and the internet module 684 are examples of modules which operate under the control of the CPU 520. The CPU 520 selectively enables and disables modules at various times to promote table turns in a restaurant or to capture revenue that might be otherwise lost because a user stays at a table or uses a display for an extended time.

As mentioned above, the number of touches as well as content touched is stored. The data base or touch log could be used to collect payment or to reconcile accounts on a pay per touch Internet advertising model. In a pay per touch advertising model advertisers would pay their host only when their ad is touched. The owners of the table system could be charged on a fixed price per touch rather than use other payment systems. Cost per touch would be an amount of money an advertiser pays an Internet publisher, such as the owners of the table systems, for a single touch on its advertisement that brings one visitor to their website. A database kept on the part of the table system owner, could be used to account for payments or to reconcile accounts between the publisher, or table owner, and the advertiser. In one embodiment, advertisements will displayed on the table system when a keyword query matches an advertiser's keyword list, or when a table system displays relevant content.

A computer-implemented method includes analyzing, by a computer, data bases of touches or touch logs. The touch logs can be analyzed to determine payment for Internet advertising. Touch logs could also be used for other analysis. For example, touch logs and query logs; could be analyzed, by a computer system (microprocessor and memory), for statistical search patterns associated with content items based on the analysis of the touch logs and query logs, wherein each statistical search pattern is defined by a plurality of queries sequenced in an order in which the queries were provided for a previous search sessions. Search sessions could be related to previous search sessions or to other attributes associated with the user of the table system. Content items could then be related to or associated with a statistical search pattern. In another embodiment, touch logs could be used to define content items responsive to previous search session queries.

The computer can further merge the current data sensed at the table with historical data relating to the specific user or the specific location of the table. This merged data can drive advertising to the table top.

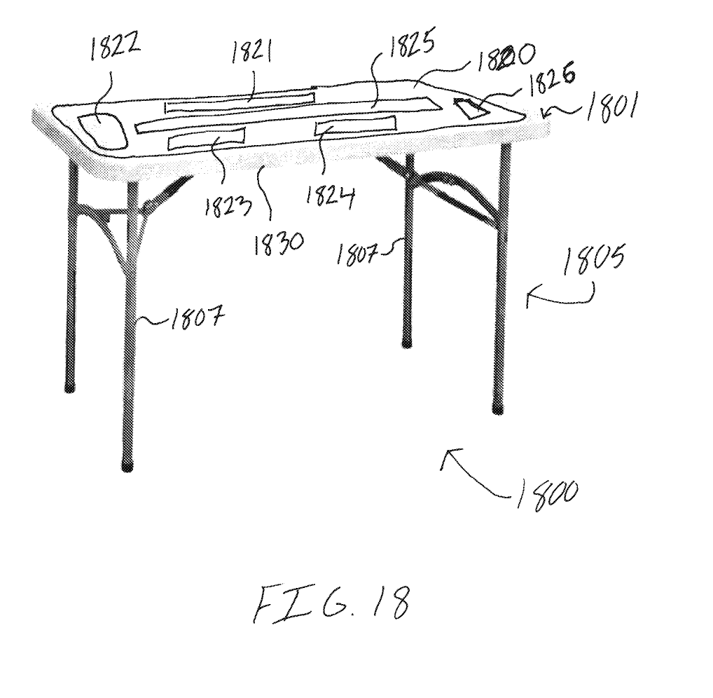

FIG. 16 shows a video system that can be used to monitor patrons or students or other users 1601 of table systems 1620, which include a touchscreen display, according to an example embodiment. In some settings, it would be advantageous to monitor users. For example, if a table is used as a desk in a learning environment, it would advantageous to know certain things such as if the student is paying attention, or if the student is cheating, or sleeping. A video system could be used to monitor these and other actions. As shown in FIG. 16, a set of small video cameras 1610, 1612 are positioned either within the table or at the surface of the table. The video cameras 1610, 1612 are positioned to look upwardly toward the user's face or head or eyes. In this way, the video monitors or cameras can be used to determine the length of time a person reviews a particular portion of an educational program, or how long a user 1601 is reviews an advertisement. Information can be gathered and reports generated from the information gathered. Another possible way to charge advertisers is on the basis of an impression. In some instances an impression is a measure of the number of times an advertisement is delivered to a position where the user 1601 can see the advertisement. In this embodiment, statistics could additionally be kept on the length of time the person was engaged with the advertisement. For example, a person that glances at an ad and moves on may be thought to have a low interest rate while others that are engaged with an advertisement for a longer period of time can be thought of as having a higher level of interest. The length of the impression could be measured as a new basis for charging advertisers by Internet or other publishers. This could also be combined with either a data base of touches, such as a touch log, to determine if there was a touch that delivered the customer to the advertiser's web site accompanied a particular impression. Thus the data from the touches and data as to the length of the impression could be used as a new basis for Internet publishers to charge advertisers. Students can also be monitored using the video cameras 1610, 1612 shown in FIG. 16. For example, if the students head is constantly turned two bits of data can be gleaned. The student is not paying attention to the table or desk surface which includes the display and he or she may be working off another's screen or cheating. The effectiveness of lessons and the effectiveness of portions of a lesson can also be measured. Information about the effectiveness can be reported to teachers, authors or others so that they can change the lesson or the portion of the lesson that may be weak. The lesson can also be correlated to test scores as a further determination of the effectiveness of the learning tool or lesson. It should also be noted that the table 1620 can include multiple users, such as user 1601. In some embodiments, more than one user can be monitored and information obtained by a set of monitors, such as monitors 1610, 1612.

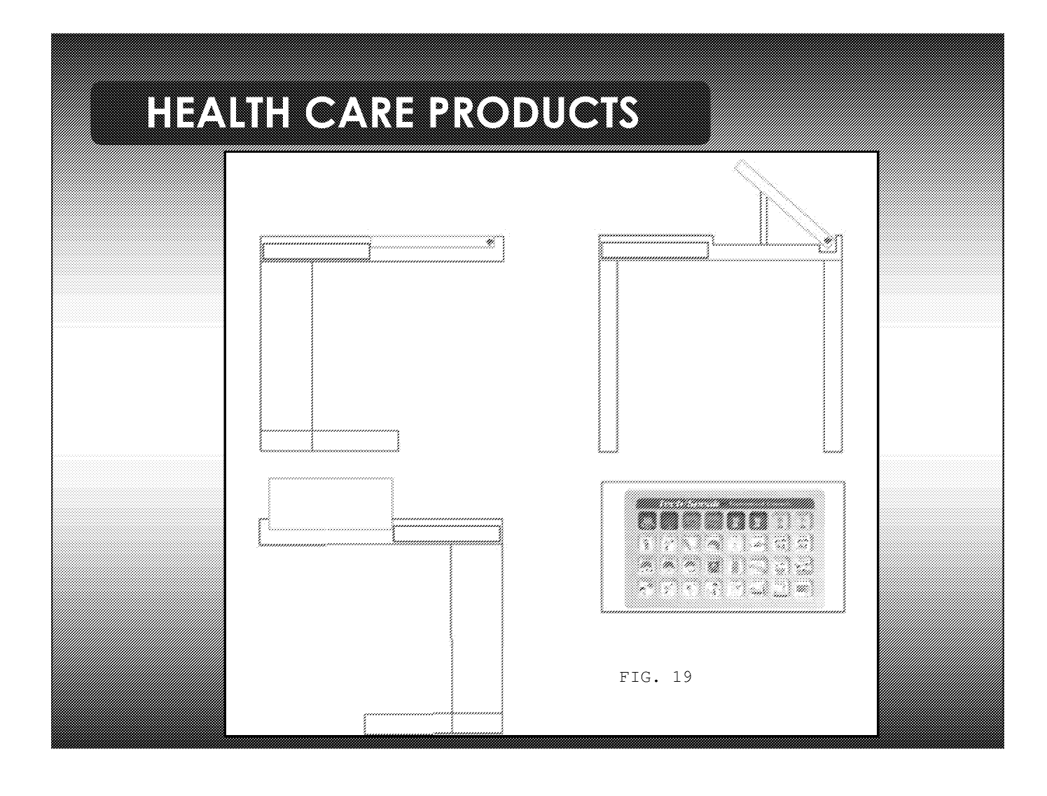

FIG. 17 shows another video system that can be used to monitor patrons or students or other users of the table systems, according to an example embodiment. For example, as illustrated in the example embodiment of FIG. 17, video cameras 1710 and 1712 are mounted overhead and look down on the student or user 1701. Gestures can be detected. Gestures can be indicative of other events. For example, the table 1720 and the video camera(s) 1710, 1712 could be configured or designed to include computer vision hand tracking functionality via the use of one or more visible spectrum cameras Using one or more of the overhead cameras, 1710, 1712, users' hands on or over the display surface may be tracked using computer hand vision tracking techniques. Data captured from the overhead camera(s) may be used to determine the different users' hand coordinates while gestures are being performed by the users on or over the display surface.

FIG. 7 illustrates a top view of a table 700, according to another example embodiment. Rather than have a single integral ruggedized display, table 700 includes a plurality of separate touch screen displays in a substantially flat orientation. The table top includes displays 710, 720, 730, and 740. If four users are at the table having table 700, there is no need to define user areas. Each display functions as a user area. In the event there are more than four users, at least one display, such as display 710, is divided into user areas and further subdivided into subareas similar to the display 400 as discussed above. It should also be noted that each of the displays 710, 720, 730 and 740 include a computer or computing device 712, 722, 732, 742, respectively. In another embodiment, the displays 710, 720, 730, 740 could run off of a server. A counter 300 (FIG. 3) could also be provided with a number of separate displays that could be coupled to a server. This configuration could be used in a conference room where an individual display may not be large enough to cover the entire conference table top.

In operation, the computer system 600 operates on a set of instructions called software. FIG. 8 illustrates a flow chart of a method 800 for displaying information on a table top touch screen display, according to an example embodiment. The computerized method 800 for displaying information on a substantially horizontal table including a touch screen display is performed by an instruction set. The method 800 includes using a memory device and a processor, and dividing a display into at least two user defined user areas 810. The method 800 also includes displaying content and information related to the first user in subareas of the first user area 812, and associating inputs from a first user area with a first user 814. The method 800 also includes displaying content and information related to the second user in subareas of the second user area 816, and associating inputs from a second user area with a second user 818. The information and content in at least one of the subareas relates to menu options to allow selecting of menu items using the display as an input device to an ordering system. The menu items can also be a menu of entertainment options, other than just food and beverage items. The menu could be a menu of services or products available in the particular hospitality environment. The areas can also be providing different interaction using different programming modules assigned to different members of the military, e.g., a command module, an operations, module, intelligence, module, communications module, engineering module, etc. The computerized method also includes communicatively coupling the memory device and processor associated with the display to an internet connection 820. Displaying content and information related to the first user 812 includes displaying content and information related to an internet application. The computerized method 800 further includes presenting a bill for a first user in the first user area 822, and providing a payment device on the substantially horizontal table to allow the first user to pay the bill at the table 824. The computerized method 800 also includes moving content from a subarea in the first user area to a second user area in response to an input stroke starting in the first user area and ending in the second user area 826. It should be noted that different types of strokes on the touch screen can be used to invoke different commands. Different commands can also be invoked by the length of the touch or certain gestures designed into the system as commands. For example, drawing an “S” with your finger on the screen can activate a certain command such as sending content to another user. It is also contemplated that movement of content could be accomplished by calling up or presenting an icon to the user. The user could then designate another user to send the content to and then push a virtual button associated with the icon to activate the send content command. Of course, one of as one of the first user or the second user are inputting information, data or information associated with another user area or a non user area may be changed in response to the input.

In some embodiments, another computerized method 900 is also included. The computerized method 900 includes detecting an object on the display 910, determining if a subarea carrying content is located below the object 912, and moving the content of a subarea below the object to another subarea outside the area below the object 914.

Another embodiment of the computerized method 1000 includes detecting an object on the display 1010, determining if a subarea carrying content is located below the object 1012, and resizing the subareas on the display within the first user area to move the content of a subarea below the object to a position where the first user is able to view the subareas 1014. Other methods could include a detection of movement. For example, if a plate is moved from directly in front of the patron to a location remote from the patron or to the edge of a table, this could be detected. This could also be used to trigger another event like sending a server or bus boy over to clear the table, or the start for displaying advertising for after dinner drinks or dessert. In one embodiment, other entertainment options could be presented. In a casino, for example, a set of credits or a coupon could be issued to the patron in order to entice them to go to a gaming area. Other movements could be used to trigger other actions or even timed events. For example, when movement of a glass is detected from a position near a plate to a position near the table edge, the server may be called to ask about a refill on drinks and be prompted as to what the drink orders for the various users of the table or the Multi-User Social-Interaction table are. Another event that can be triggered in response to such a movement might be the determination of a bill for menu items selected. The menu items can be services used or food and drink. In some instances, the ordering habits of patrons may be monitored to make a determination as to whether a drink is generally to be refilled. All or some of the inputs of the user's can be monitored and stored for future analysis or to supplement information gathered currently.

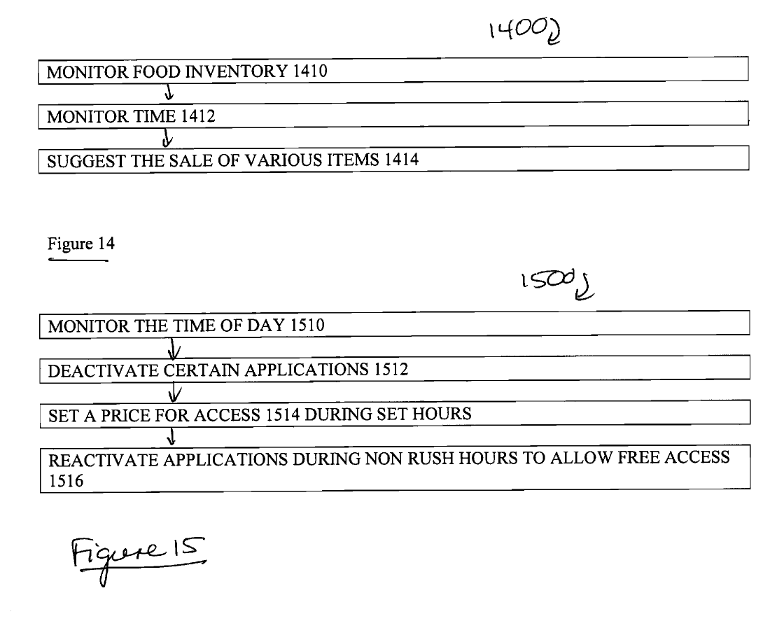

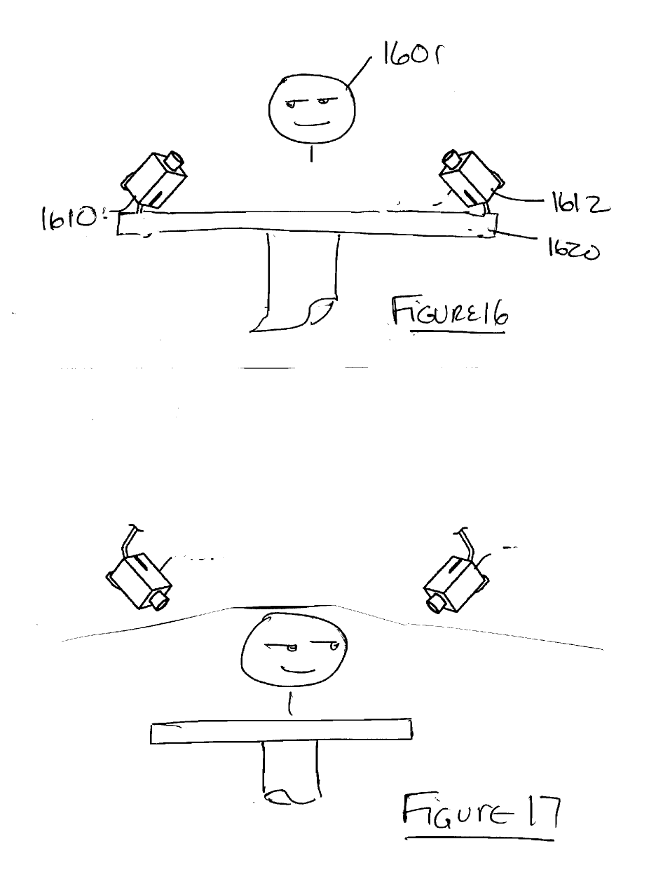

FIG. 13 shows another computerized method 1300. The computerized method includes providing a loyalty program 1310, collecting data from the loyalty program 1312, monitoring usage of the patron 1314, collecting information regarding computer usage 1316 and combining the loyalty data and the computer usage data 1318. The data can then be used to direct target advertisements to the user 1320. The user can be shown targeted advertisements while at a hospitality or desk or table. The user could also be shown targeted advertisements at a later time either by sending E-mails to the user or by detecting when the user is using a computer and providing selected pop up advertisements via the user interface. Points could be awarded for purchases made as well as other non purchase actions. For example, viewing a particular advertiser's website might produce loyalty points. Filling out a contact information form at another advertiser's website might produce another award credit level. Scanning advertising data associated with a coupon may be another action that triggers a credit in a loyalty point program for a customer. Other actions that may trigger loyalty program credits may be the playing of audio at selected times or linking to a particular offer database. FIG. 14 is a flow diagram for a use of the advertising module 680 (shown in FIG. 6), according to one embodiment. The advertising module could be provided with one or more sub modules, including a suggestive seller module. The suggestive seller module could be used to suggest or sell various items in real time. The method 1400 would include monitoring food inventory 1410, monitoring time 1412 and suggesting the sale of various items 1414. For example, if a certain menu item is set to expire or is overstocked, the suggestive seller module could be used to provide a special featuring the item or items that the restaurant is overstocked in or that may have to be discarded in the next 3-4 days. The suggestive selling module could also attempt to up sell patrons. For example, if steaks were ordered, it could suggest a high margin wine to go along with the meal. The up sell could be provided at the time of ordering or part way through a meal. Up selling could also be used to suggest after dinner drinks for example. In addition, the suggestive seller module could be used to discount menu items at various times of the day in order to even out the patronage in the restaurant. For example, several hours before a rush time, there could be a discount to get a number of patrons into a restaurant before the rush time. The number of patrons could also be monitored so that the discounts would discontinue at a time when a selected number of patrons were at the restaurant. This could also be timed so that there would be a time buffer between when the prices were at rush hour prices.

FIG. 15 is another flow diagram associated with a method associated with the hospitality computing system. The method 1500 includes monitoring the time of day 1510. Based on the time of day, the method 1500 includes deactivating certain applications 1512 and setting a price for access 1514 during set hours and reactivating applications during non rush hours 1516. In essence, this would dissuade patrons from getting a cup of coffee at a restaurant and sitting on the internet through a meal. An amount of profit for a table could be determined and the amount charged for the internet during “rush” hour could be used to recoup profit from a patron that has decided to sit through a rush time. In addition, certain applications could be turned on based on an amount to be spent. For example, a patron might come in during a rush hour and be prompted to accept a minimum charge for internet access and a meal. Certain applications could be provided for free during non-rush times to persuade patrons to visit during off hours.

FIG. 11 is a schematic diagram of a computer readable medium 1100, according to an embodiment. The computer readable media, which is sometimes referred to as machine readable medium, 1100 includes a set of instructions 1110 which are executable by a machine such as a computer system. When executed, the machine follows the instruction set 1110. The computer readable media can be any type of media including memory, floppy disk drives, hard disk drive, and a connection to the internet or even a server which stores the machine at a remote location. The computer-readable medium or machine-readable medium 1100 provide instructions that, when executed by a machine, cause the machine to implement the methods 800, 900, and 1100 as well as other methods associated and discussed with respect to FIGS. 1-10 above.

Various implementations of the subject matter of the method and apparatus described above may be realized in digital electronic circuitry, integrated circuitry, specially designed ASICs (application specific integrated circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the term “machine-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the method and apparatus described above may be implemented on a computer having a display device, such as the ruggedized touch screen 400 discussed above, for displaying information to the user. Other input devices, such as a keyboard and a pointing device (e.g., a mouse or a trackball) by which the user may provide input to the computer. These input devices could be plugged into a port such as a USB port (similar to port 320 of FIG. 3), The input devices could also be provided on the touch screen 400 as virtual input devices, such as virtual keyboards, virtual keypads, virtual mouse, and the like. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

FIG. 12 illustrates a touch screen 400 that includes a user area 410. The user area 410 is subdivided into a first subarea 412, a second subarea 414 and a third subarea 416. The subarea 416 includes a set of virtual keyboards 1210, 1212, 1214, 1216. One of the virtual keyboards 1210, 1212, 1214, 1216 is selected and used for input of information. In another embodiment, a single virtual keyboard or virtual input device could be displayed and a number of alternative virtual input devices could be accessed by touching or clicking on icons which would also be provided on screen. In addition, one of the subareas, such as subarea 412, can be dedicated to content which provides advertising, for example. The content provided could also be targeted advertising. In another embodiment, the content could be television produced by another and fed to the display for viewing. In another embodiment, the content could be a video that both entertains and includes spots for advertisements.

FIG. 18 shows a table computing device 1800 that can implement the various methods, processes and structures described herein, Device 1800 can be used in military environments, Device 1800 includes a tabletop computer 1801 supported by a support structure 1805. Leg structure 1805 can include foldable legs 1807 that can fold and extend beneath the tabletop computer 1801 to reduce the volume of the device 1800 for transportation. In an example, the legs 180 can lie flat against an underside of the tabletop computer 1801. The legs 1807 can be extended, as shown in FIG. 18 to position the tabletop computer 1801 at a vertical position above the ground or floor. The support structure 1805 can further include a lock structure to hold the legs 1807 in a vertical, extended position. The lock structure can further fold the legs in the folded, retracted position beneath the tabletop computer 1801. In an example, the top of the tabletop computer 1801 includes a touch screen 1820 in a housing 1830. The touch screen 1820 that can provide the multiple user areas 1821-1824 each with touch screen inputs associated with that area. Subareas as described herein can also be defined in the touch screen 1820. An application menu bar area 1825 can also be displayed on the touch screen 1820. While shown as a longitudinal central area, the area 1825 can be sized based on the number and shape of the other areas. The size and shape of area 1825 can be determined by the computer 1826. The computer 1826 is embedded in the housing 1830 in the illustrated embodiment. The computer 1826 can communicate with other computing devices using communications described herein. The device 1801 can be manufactured to at least NEMA 4 standards and can provide protection to personnel and to the device against incidental contact with the enclosed equipment; equipment protection against falling dirt, rain, sleet, snow, windblown dust, splashing water, and hose-directed water; and against the external formation of ice on the device.

In an example, the housing 1830 of the tabletop computer 1801 can include an air tight, hermetically sealed, heat conductive four side walls, a bottom wall, and a top recess. The top recess is adapted to receive the touch screen 1820. The recess can further include a peripheral lip that receives a resilient, seal to provide an air, dirt and liquid tight seal between the peripheral lip of the housing and the touch screen 1820. A transparent cover can be provided on the top of the touch screen of the tabletop computer 1801 that can act with the seal to seal to provide a barrier to moisture, dust, and debris from entering the interior of the computer.

The housing 1830 can further provide shock-absorbing mounts to which the touch screen 1820 can be mounted. The mounts are designed to absorb large one mechanical forces that can be generated when the device 1801 is dropped from heights of one foot or greater. The mounts can also absorb repeated mechanical vibrations, e.g., when the device 1801 is in transport in a vehicle, e.g., truck, plane, tank, troop transport, etc.

The device 1800 can provide hardware and implement instructions stored in a machine readable format that may allow operational officers to make better decisions faster. The tabletop computer 1801 may digitally create a common operational picture (COP) of all components involved with developing a safe, secure, and functional base camp. These components can be reviewed, revised, and replicated in a matter of seconds with a few finger gestures entered into the tabletop computer 1801 through the touch screen. As a result, the present device can streamline base camp operations and provide the highest level of efficiency, so other tasks may be completed ahead of schedule. Once adopted in a military environment, this device and related systems can be utilized in other facets such as battlefield simulations, tactical rehearsals, and operational order development, as well as pre-mission planning and officer training This device 1801 reduces the time and space requirement for planning base camp defense, quick reaction forces (QRF) and logistics. The device 1801, after being used to establish the base camp, can load new instructions that are used by commander(s) and staff to conduct multi-echelon training and deployment, e.g., the instructions loaded into the device 1801 are used to implement the contemporary operational environment (COE) and high intensity conflict (HIC) situations. The instructions can be written in Microsoft's™ framework. The device 1801 is mobile, weighs 60 pounds or less, at most 6″ thick, environmentally sealed, shock mounted, scratch-resistant, durable, and has the ability to work in multiple environments by multiple users for multiple functions of the military at the same time. The device 1801 can process at least 20 simultaneous touches on the touch screen, which can be divided into a plurality of different area, e.g., up to 10 different areas. In an example, the touch screen has a dimension of at least 40 inches. In an example the touch screen is at least 40 inches in length and at least 30 inches in width.

The device 1801 can electronically communicate of other electronic devices to update maps, orders, missions, location of enemy and friendlies. Moreover, new instructions and applications can be remotely loaded to the device 1801.

In a base camp deployment process, the device 1801 can implement the following instructions. The base camp development application will include, but not be limited to, the following items that can be implemented on the device 1801 with multiple people to work at one device 1801. The device can display cartography related to the physical site of the camp, e.g., aerial images from Google™ Earth or similar program. This image can be displayed in areas on the device 1801 and used for logistical layout. Other military images can be used. The users can interact with the device 1801 using methods described herein, e.g., gestures, touch events, and input from either a stylus, a finger, or a gloved hand to input information into the device. The instructions can further store a catalog of graphic icons which represent all of the logistics features needed for deployment of a camp or other military deployments. Instructions can implement modules on the device for specific team member planning based on usage or rank. Other instructions can provide computer aided drafting tools to layout lines, points, and areas, which can be changed, interacted with via touch input. The instructions can further allow the ability to drag and drop pre-defined graphical and spatially correct features. The instructions can further define an export module to relay the design information to the builder in a pre-defined format. Instructions can further output plans to hard copy devices such as plotters and printers. Other features that can be implemented include, but are not limited to, • additional geospatial tools such square footage calculations, liner distance measurements, and real-time GPS coordinate information input. The instructions can further integrate with current or future development tools such AT Planner, Facilities Components Systems, Terrain Modeling System, Mobile Combat System Engineer or similar decision support technologies, and time and cost modeling development tools.

The table system as described herein can be used to select a specific course of action from a plurality of courses of actions that may be applicable to the environment of users of the table system. The courses of actions to consider or not to consider can include both friendly and enemy possible actions, which can each have a priority or hierarchy for addressing them. These can be stored as instructions in the table system. In an example, the instructions embodying the courses of action can include at least one of reconnaissance guidance, risk guidance, deception guidance, fire support guidance/deep operations guidance, mobility and countermobility guidance, security measures to be implemented in this environment, additional specific priorities for combat support and combat service support, and any other information the commander would like the staff to consider. The instructions can further require timing of any plan or course of action. Based on the timing, the instructions can require updates to data, e.g., weather, cloud cover, moonlight, length of daylight or any other data that may impact the course of action.

The instructions stored or displayed on the table can include military important geography, absolute combat abilities, relative combat abilities, and enemy combat abilities as previously understood and as updated by personnel in the field. The instructions can further list assumptions and request that the assumptions be confirmed as various planning stages or at various execution stages. The instructions can further provide predictive courses of action that an enemy will likely take based on selected input by the users of the table.

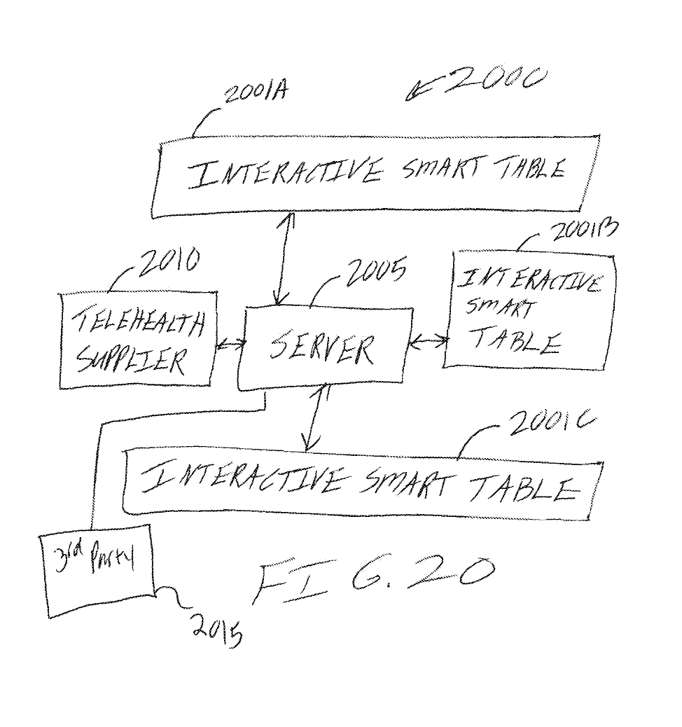

FIG. 19 shows schematic views of a table 1900 with various supports that hold the interactive display above a floor. The supports can be legs at least three locations to support an upper portion above the floor. In an example, the support can be along one side of the upper portion such that the upper portion cantilevers from the top of the support. The interactive display can be flat with the remainder of the upper portion of the table in an example. The interactive display can be pivoted upwardly about an axis at one side of the upper portion of the table. A support can hold the display in the pivoted upright position. The upright position can be at an angle relative to horizontal, e.g., the top surface of the upper portion.

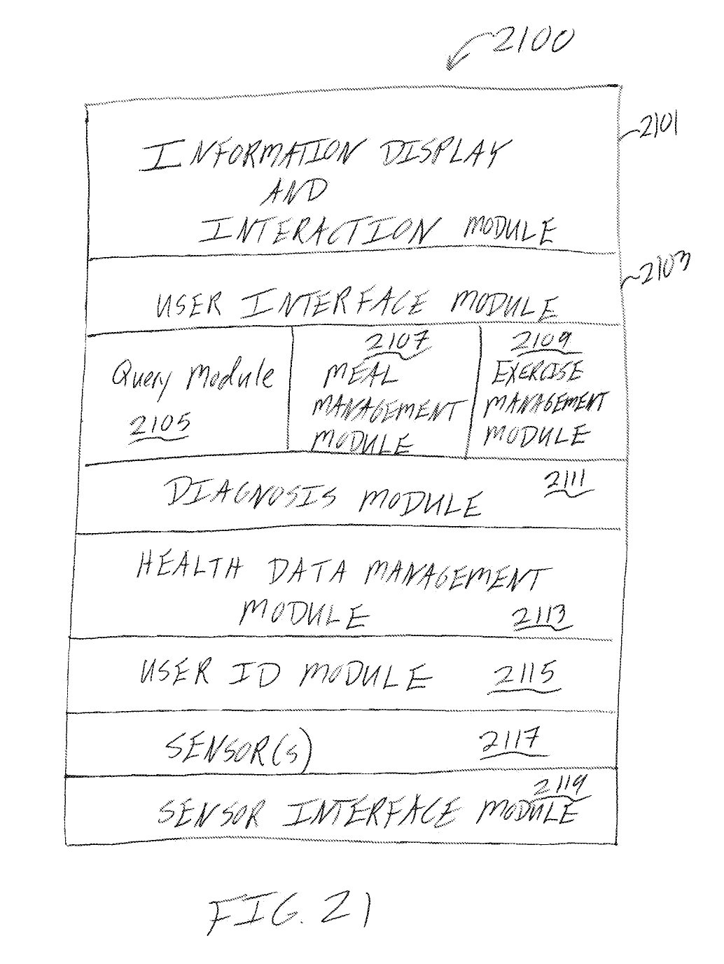

FIG. 20 shows a schematic view of a system 2000 with a plurality of interactive, smart tables 2001A, 2001B, 2001C, . . . that can each communicate with a central service 2005. The central server 2005 can communicate with a further computing machine 2010 that can provide telehealth services. The machine 2010 can include processors operably connected to the memories. The memories can store instructions that can provide health care functions. The processors can execute instructions to provide health related services. The telehealth services can include delivery of health-related services and information via telecommunications technologies. The health-related services and information can be directed to specific users of a respective table 2001A, 2001B or 2001C. In an example, a physician at the machine 2010 can videoconference with a patient at a respective table 2001A, 2001B or 2001C through server 2005. Telehealth as used herein can include telemedicine. Telehealth can provide preventive and curative healthcare to user's of the tables 2001. The tables 2001 and machine 2010 can include other means of communication such as email, text, audio, etc. These means can be update prescriptions, which can be electronically communicated to a third party 2015, e.g., a pharmacy.

The tables 2001 can take images and audio of the user as well as store health related data, e.g., from sensors.

FIG. 21 shows a schematic view of a patient interactivity unit 2100, which can be a table as described herein. Unit 2100 can include various hardware, firmware, software, and combinations thereof. Processor(s) can be operatively connected to memory or memories to execute and provide the functionality required to provide health care methods. An information display and interaction module 2101 is provided to give images to a user and allow the user to interact with the unit 2100. A user interface module 2103 outputs data to the module 2101 for display and receives electrical signals from the module 2101 to define input data. The module 2101 can be adjusted for color, icon size, image size, or size of font to adapt the display to the needs of a user. The module can then adjust the sensing of inputs based on the adjusted display.

A query module 2105 can operate to output questions to the user through modules 2101, 2103 that can adjust operation of the device 2100 or used to challenge the mental acuity of the user. Such interaction can help a user maintain mental abilities. The queries from the module 2105 can further be used to diagnose the user, e.g., using diagnosis module 2111. The query module 2105 can further remind the patient to take his/her prescription at an appropriate time.

A meal management module 2107 can output meal suggestions based on a meal plan input into the device, e.g., by a medical care provider or nutritionist. The module 2107 can also store a meal database or interact with a remote meal database that provides meal suggestions based on data related to the a user. Examples of the data can include the diagnosed disease of the user, user health data, whether on a sodium restricted diet, and basal metabolic rate, and other personalized restrictions. The module 2107 can then decide on nutrient type(s) and amounts required for a specific user. The module can also recommend meals comparing a user's preference with a suggested food list. The user can enter feedback to the module using the modules 2101, 2103.

An exercise management module 2109 can output an exercise schedule (e.g., a program) to the user. The exercise management module 2109 can recommend types of exercise or type of sport that would be suitable to a specific user. The exercise module 2109 can be uploaded by a medical provider and can be remotely changed based on the health of the user. The type, quantity, and intensity of the exercise can be changed based on the user's health. The exercise management module 2109 can receive data from the user via the modules 2101, 2103 regarding the exercise completed by the user. The user can retrieve stored data regarding their exercise schedule.

The diagnosis module 2111 can use data in the unit 2100 from wither the module 2101 or through sensors 2117 or sensor interface module 2119. The diagnosis module 2111 can determine the medical or health condition of the user.

A health data management module 2113 operated to store health related data in compliance with law and security of the patient information. In an example, the module 2113 encrypts the user's health data.

User identification module 2115 operates to identify a specific user to implement the appropriate instructions and data in the unit 2100. Module 2115 can include a bio-sensor, e.g., iris scanner, fingerprint reader, etc. Module 2115 can include a person an identification number or code that can be input in the interaction module 2101.

The sensor(s) 2117 can be health related sensor(s) directly connected to the unit or integral therewith. In an example, the sensor is a blood glucose monitor. In an example, the sensor is a blood pressure monitor. In an example, the sensor is a heart rate monitor. In an example, the sensor is a scale. In an example, the sensor is a blood oxygen monitor. In an example, the sensor is an implant with wireless communication function. The implant can be an internal cardio defibrillator or pacemaker. In an example, the sensor is an EEG monitor. In an example, the sensor is home-based dialysis machine.

A sensor interface module 2119 provides inputs into the unit 2100 such that additional devices that operate as sensors can communicate with the device.

The tables and systems as described herein can be used to sense and store observations of daily living (observation data) are input from a user that may be indicators of health, physical and mental health. Observation data can be different from signs, symptoms, and clinical indicators in that they can be defined by the patient and may not necessarily be directly mapped to biomedical models of disease and illness. Examples of observation data can include sleep patterns, exercise behavior, nutritional intake, attitudes, moods, alertness at work or in class, and environmental features such as clutter in the living or working space. Not all patient-generated data in the tables constitute observation data. For example, a patient with diabetes may record their blood glucose levels everyday at home, hence generating data to share with their clinician. That kind of patient-generated data is crucial to inform clinical decision making, but does not constitute observation data. observation data are typically defined by patients and their families because they are meaningful to the patient, and help them self-manage their health and make appropriate health decisions. Observation data may complement biomedical indicators and inform medical decision making by providing a more complete and holistic view of the patient as a whole person, provided they are properly integrated in clinical workflows and supported by health information technologies. Integration can be performed by the telehealth supplier, e.g., computing device 2010 of FIG. 20.

Various telehealth devices, systems and functions are described in U.S. Pat. Nos. 7,421,367; 7,304,582 and 6,168,563 and US Patent Publication No. 2006/0154642. These documents are incorporated by reference for any purpose. However, if the subject matter of these documents conflicts with the present disclosure, the present disclosure will control interpretation.

It will also be recognized that the table can be networked to other computer and communication systems to provide coordinated information and coordinated operations. This can be useful when the table is deployed in the field and not merely at a safer, headquarters environment. The users can implement the instructions on the tab le to provide suitable coordinated responses for its region of command in view of the variety of real-time constraints and the local data in real-time. Moreover, the table can communicate this data to and receive data from multiple sources to further refine the command abilities of the users implemented through the table computing system. That is, the table can assist in developing or implements a deployment plan to get the resources in place and can monitor the employment of these resources as well as provide crisis, real-time change of plans. The table can be used at the strategic, operation and tactile levels.

The table can provide for war gaming with distinct areas of the table being assigned to control different elements of a potential battlefield. For example, one area can be assigned to air support. Another area can be assigned to ground troops. A further area can be heavy artillery. The same elements can be replicated for the enemy forces as well. A central area of the table can show the entire battlefield or portions of the battlefield overlaid with the position of both sides. In an example, the table can further display the topographical information and apply the topography to any proposed movements of the elements of the battlefield.

The presently described table can allow operational officers make improved decisions more efficiently by providing a common operational picture with inputs by the various officers and other data sources to keep the common operational picture current with how changes will affect the common operational picture. The components of the common operational picture can be reviewed, revised, and replicated with the use of finger gestures on the table or, in an alternate example, near the table. These can include battlefield scenarios and simulations, tactical rehearsals, and operational order development. The table can be used in pre-mission planning as well as during a mission or deployment.

The methods and apparatus described and contemplated above may be implemented in a computing system that includes a back-end component (e.g., as a data server), or that includes a middleware component (e.g., an application server), or that includes a front-end component (e.g., a client computer having a graphical user interface or a Web browser through which a user may interact with an implementation of the subject matter), or any combination of such back-end, middleware, or front-end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

A table includes: a substantially horizontal table top to be supported at a level above seats adjacent the table top. The table top includes a substantially horizontally extending touch-sensitive display. The table also includes a computing device in communication with the display to receive touch signals. The computing device defines multiple user areas on the display. The multiple user areas are oriented to users seated at the table top. The table top receives multiple touches on the display essentially or substantially concurrently. The multiple touches provide distinct control signals to the computing device to control operation of the computing device. The users at the table top can individually order at least one of food and beverage through respective user areas. The table can include a housing. The display, in one embodiment, is positioned substantially within the housing. In some embodiments, the computing device is substantially built within the table top. An output device is in communication with the computing device associated with the table top. One such output device includes a printer that is associated within the housing of the table top. The display is a single, unitary display that is virtually divided into at least two user areas. In one embodiment, the users of the table or the Multi-User Social-Interaction Table define the virtual division into user areas. At least one user area is divided into a plurality of sub areas. At least two of the sub areas include different content. In one embodiment, the computing device includes a transfer module, the transfer module transferring subareas between different user areas based on a touch in a source subarea of the display. When the display is virtually divided into user areas, an input placed into a first user area is associated with a first user, and an input placed into a second user area is associated with a second user. Inputs into a first user area and inputs into a second user area can be received substantially concurrently. In another embodiment, the touch sensitive display includes a module that identifies a common shape produced by an object physically placed on the table top display. Certain devices, such as an RFID tag, could trigger an event in response to the certain device being detected or coming into contact with the touch screen 400. The computing system determines if a display item is within the common shape and moves the display item to a position outside the shape when the object is positioned on the table top display. In some embodiments, the table system includes a portion for paying a bill. In some instances, this includes a credit card reader. The credit card reader is associated within the housing of the table top, or otherwise attached to the computing device and touch screen 400 of the table.

Thus, disclosed above is a computer system for displaying information on a substantially horizontal table includes a touch-screen display. The touch-screen display is substantially horizontally positioned within the table. The computer system includes a processor, and a memory device communicatively coupled to the processor. The computer system includes a display division module for dividing a display into at least a first user defined area and a second user defined area. The computer system also includes a first association module and a second association module. The first association module associates inputs from a first user area with a first user and associates content and information selected for display by the first user with the first user. The second association module associates inputs from a second user area with a second user and associates content and information selected for display by the second user with the second user. At least some of the information and content in at least one of the first or second user areas relates to menu items to allow ordering of menu items using the display as an input device to a restaurant ordering system. The display division module divides the display into a first user area and a second user area based on input from at least the first user. The computer system also includes a module for subdividing a user area into subareas. The computer system displays information and content associated with a user in the subareas. At least one of the subareas includes an interface of options and a bill for at least the first user. The computer system also includes an object detection module for detecting an object on the touch screen display and determining if a subarea carrying content is located below the object. The computer system also includes a subarea movement module for moving a subarea below the object to a portion of the first user area viewable by the first user. The computer system also includes a bill paying module located at the table or Multi-User Social-Interaction Table. The computer system also includes a content moving module for moving content from a subarea in the first user area to a second user area in response to an input stroke starting in the first user area and ending in the second user area.

Also disclosed is a computerized method for displaying information on a substantially horizontal table including a touch screen display, the method includes using a memory device and a processor, and dividing a display into at least two user defined user areas. The method also includes displaying content and information related to the first user in subareas of the first user area, and associating inputs from a first user area with a first user. The method also includes displaying content and information related to the second user in subareas of the second user area, and associating inputs from a second user area with a second user. The information and content in at least one of the subareas relates to menu items to allow ordering of menu items using the display as an input device to an ordering system. The computerized method also includes communicatively coupling the memory device and processor associated with the display to an internet connection. Displaying content and information related to the first user includes displaying content and information related to an internet application. The computerized method further includes presenting a bill for a first user in the first user area, and providing a payment device on the substantially horizontal table to allow the first user to pay the bill at the table. The computerized method also includes detecting an object on the display, determining if a subarea carrying content is located below the object, and moving the content of a subarea below the object to another subarea outside the area below the object. Another embodiment of the computerized method includes detecting an object on the display, determining if a subarea carrying content is located below the object, and resizing the subareas on the display within the first user area to move the content of a subarea below the object to a position where the first user is able to view the subareas. The computerized method also includes moving content from a subarea in the first user area to a second user area in response to an input stroke starting in the first user area and ending in the second user area.

The table top is described herein an electro-mechanical device that received mechanical inputs from a user or users and converts those to electrical signals for storage or as an input to a computing device. The table top display divides a unitary electro-mechanical device into a plurality of subareas as described herein.

In an example, a military field table system comprises: a substantially horizontal table top to be supported at a level above the ground, the table top including a substantially horizontally extending display, which is touch sensitive, the table top having a thickness less than or equal to twelve inches; a computing device in communication with the display to receive touch signals, the computing device to define multiple user areas on the display, the multiple user areas being oriented to users seated at the table top; wherein the table top is to receive multiple touches on the display essentially concurrently; wherein the multiple touches are determined to provide distinct control signals to the computing device to control operation of the computing device; and wherein the users at the table top can individually select menu items through respective user areas. The table system described herein can include the substantially horizontal table top further comprising a housing, the display substantially within the housing, which protects the display from environmental damage. The table system described herein can include the computing device is contained substantially within the table top. The table system described herein can include an output device in communication with the computing device. The table system described herein can include a printer, the printer associated within the housing of the table top. The table system described herein can include the display being a single, unitary display that is virtually dividable into at least two user areas. The table system described herein can include the display being virtually divided into user areas defined by a plurality of users. The table system described herein can include at least one user area divided into a plurality of sub areas, wherein at least two of the sub areas each include different content. The table system described herein can include the computing device having a transfer module, the transfer module transferring subareas between different user areas based on a touch in a source subarea of the display. The table system described herein can include the display being virtually divided into user areas, wherein an input placed into a first user areas is associated with a first user, and an input placed into a second user area is associated with a second user. The table system described herein can include inputs into a first user area and inputs into a second user area can be received substantially concurrently. The table system described herein can include the touch sensitive display having a module that identifies a common shape produced by an object physically placed on the table top display, the computing system determining if a display item is within the common shape and moving the display item to a position outside the shape when the object is positioned on the table top display. The table system described herein can include a credit card reader, the credit card reader associated with the housing of the table top.

In an example, a computer system for displaying information on a substantially horizontal military table including a touch-screen display comprises: a processor; a memory device communicatively coupled to the processor, the touch-screen display also communicatively coupled to the memory and processor; a display division module for dividing a display into at least a first user defined area and a second user defined area; a first association module for associating inputs from a first user area with a first user and for associating content and information selected for display by the first user with the first user; a second association module for associating inputs from a second user area with a second user and for associating content and information selected for display by the second user with the second user; wherein at least some of the information and content in at least one of the first or second user areas relates to menu items. The computer system or table system described herein can include the display division module dividing the display into a first user area and a second user area based on input from at least the first user. The computer system or table system described herein can include a module for subdividing a user area into subareas, the computer system displaying information and content associated with a user in the subareas, wherein at least one of the subareas includes an interface to an application for presenting a menu options for at least a first user. The computer system or table system described herein can include an object detection module for detecting an object on the touch screen display and determining if a subarea carrying content is located below the object; and a subarea movement module for moving subarea below the object to a portion of the first user area viewable by the first user. The computer system or table system described herein can include a bill paying module located at the table. The computer system or table system described herein can include a content moving module for moving content from a subarea in the first user area to a second user area in response to an input stroke starting in the first user area and ending in the second user area. The computer system or table system described herein can include a content moving module for moving content from a subarea in the first user area to a second user area in response to an input stroke at an icon for moving content from the first user area to the second user area.

The present disclosure further includes methods that may operate using the structures described herein. In an example, a computerized method for displaying information on a substantially horizontal table including a touch screen display, the method comprising: using a memory device and a processor, dividing a display into at least two user defined user areas; displaying content and information related to the first user in subareas of the first user area; associating inputs from a first user area with a first user; displaying content and information related to the second user in subareas of the second user area; associating inputs from a second user area with a second user, wherein the information and content in at least one of the subareas relates to items to allow selecting one of items using the display as an input device to a military system. The methods herein can include communicatively coupling the memory device and processor associated with the display to an internet connection, wherein displaying content and information related to the first user includes internet applications. The methods herein can include presenting a bill for a first user in the first user area; and providing a payment device on the substantially horizontal table to allow the first user to pay the bill at the table. The methods herein can include detecting an object on the display; determining if a subarea carrying content is located below the object; and moving the content of a subarea below the object to another subarea outside the area below the object. The methods herein can include detecting an object on the display; determining if a subarea carrying content is located below the object; and resizing the subareas on the display within the first user area to move the content of a subarea below the object to a position where the first user is able to view the subareas. The methods herein can include moving content from a subarea in the first user area to a second user area in response to an input stroke starting in the first user area and ending in the second user area. The methods herein can include detecting an object on the display; and triggering a timing event in response to detecting an object on a display in a selected area of the display. The methods herein can include detecting a selected movement of an object on the display; and triggering an event in response to detecting the selected movement. The methods herein can include triggering the event in response to detecting the selected movement includes events remote from the display. The methods herein can include tracking at least one of the first user's inputs or the second user's inputs for analysis.

In an example, a table comprises a substantially horizontal table top to be supported at a level above the ground, the table top including a substantially horizontally extending display, which is touch sensitive, the table top having a thickness less than or equal to twelve inches; a computing device in communication with the display to receive touch signals, the computing device to define multiple user areas on the display, the multiple user areas being oriented to users seated at the table top; wherein the table top is to receive multiple touches on the display essentially concurrently; wherein the multiple touches are determined to provide distinct control signals to the computing device to control operation of the computing device; and wherein the users at the table top can individually select menu items through respective user areas. In an example, the table of the examples described herein can include the substantially horizontal table top further comprising a housing, the display substantially within the housing. In an example, the table of the examples described herein can include the computing device being contained substantially within the table top. In an example, the table of the examples described herein can include an output device in communication with the computing device. In an example, the table of the examples described herein can include a printer, the printer associated within the housing of the table top. In an example, the table of the examples described herein can include the display being a single, unitary display that is virtually dividable into at least two user areas. In an example, the table of the examples described herein can include the display being virtually divided into user areas defined by a plurality of users. In an example, the table of the examples described herein can include at least one user area being divided into a plurality of sub areas, wherein at least two of the sub areas each include different content. In an example, the table of the examples described herein can include computing device having a transfer module, the transfer module transferring subareas between different user areas based on a touch in a source subarea of the display. In an example, the table of the examples described herein can include the display being virtually divided into user areas, wherein an input placed into a first user area associated with a first user, and an input placed into a second user area is associated with a second user. In an example, the table of the examples described herein can include inputs into a first user area and inputs into a second user area can be received substantially concurrently. In an example, the table of the examples described herein can include the touch sensitive display includes a module that identifies a common shape produced by an object physically placed on the table top display, the computing system determining if a display item is within the common shape and moving the display item to a position outside the shape when the object is positioned on the table top display. In an example, the table of the examples described herein can include a credit card reader, the credit card reader associated with the housing of the table top.

In an example, a computer system for displaying information on a substantially horizontal table including a touch-screen display can comprise: a processor; a memory device communicatively coupled to the processor, the touch-screen display also communicatively coupled to the memory and processor; a display division module for dividing a display into at least a first user defined area and a second user defined area; a first association module for associating inputs from a first user area with a first user and for associating content and information selected for display by the first user with the first user; a second association module for associating inputs from a second user area with a second user and for associating content and information selected for display by the second user with the second user; wherein at least some of the information and content in at least one of the first or second user areas relates to menu items. In an example, a computer system can include the display division module dividing the display into a first user area and a second user area based on input from at least the first user. In an example, a computer system can include a module for subdividing a user area into subareas, the computer system displaying information and content associated with a user in the subareas, wherein at least one of the subareas includes an interface to an application for presenting a menu options for at least a first user. In an example, a computer system can include an object detection module for detecting an object on the touch screen display and determining if a subarea carrying content is located below the object; and a subarea movement module for moving subarea below the object to a portion of the first user area viewable by the first user. In an example, a computer system can include a bill paying module located at the restaurant-style table. In an example, a computer system can include a content moving module for moving content from a subarea in the first user area to a second user area in response to an input stroke starting in the first user area and ending in the second user area. In an example, a computer system can include a content moving module for moving content from a subarea in the first user area to a second user area in response to an input stroke at an icon for moving content from the first user area to the second user area.

The present disclosure further includes methods that may operate using the structures described herein. In an example, a computerized method for displaying information on a substantially horizontal desk including a touch screen display, the method comprises: using a memory device and a processor, dividing a display into at least two user defined user areas; displaying content and information related to the first user in subareas of the first user area; associating inputs from a first user area with a first user; displaying content and information related to the second user in subareas of the second user area; associating inputs from a second user area with a second user, wherein the information and content in at least one of the subareas relates to menu items to allow selecting of menu items using the display as an input device to an ordering system. The methods herein can include communicatively coupling the memory device and processor associated with the display to an internet connection, wherein displaying content and information related to the first user includes internet applications. The methods herein can include observing a first student in the first user area; and providing observation information about the first student's actions to the memory and processor. The methods herein can include detecting an object on the display; determining if a subarea carrying content is located below the object; and moving the content of a subarea below the object to another subarea outside the area below the object. The methods herein can include detecting an object on the display; determining if a subarea carrying content is located below the object; and resizing the subareas on the display within the first user area to move the content of a subarea below the object to a position where the first user is able to view the subareas. The methods herein can include detecting an object on the display; and triggering a timing event in response to detecting an object on a display in a selected area of the display. The methods herein can include detecting a selected movement of an object on the display; and triggering an event in response to detecting the selected movement. The methods herein can include triggering the event in response to detecting the selected movement including events remote from the display. The methods herein can include tracking at least one of the first user's inputs or the second user's inputs for analysis. The methods herein can include monitoring at least one of the first user's inputs or the second user's inputs; and changing non-sub area content in response to the monitoring.

In an example, a Multi-User Interaction Table comprises a substantially horizontal table top to be supported at a level above the ground, the table top including a substantially horizontally extending display, which is touch sensitive, the table top having a thickness less than or equal to twelve inches; a computing device in communication with the display to receive touch signals, the computing device to define multiple user areas on the display, the multiple user areas being oriented to users standing or seated at the table top; wherein the table top is to receive multiple touches on the display essentially concurrently; wherein the multiple touches are determined to provide distinct control signals to the computing device to control operation of the computing device; and wherein the users at the table top can individually select menu items through respective user areas. In an example of a table or system described herein can include the substantially horizontal table top having a housing, the display substantially within the housing. In an example of a table or system described herein can include the computing device being contained substantially within the table top. In an example of a table or system described herein can include an output device in communication with the computing device. In an example of a table or system described herein can include a printer, the printer associated within the housing of the table top. In an example of a table or system described herein can include the display being a single, unitary display that is virtually dividable into at least two user areas. Virtual divisional can be indications on the display that shows a user their individual area as opposed to other person's area. The virtual area can input more than one signal while other area also input signals. In an example of a table or system described herein can include the display being virtually divided into user areas defined by a plurality of users. In an example of a table or system described herein can include at least one user area being divided into a plurality of sub areas, wherein at least two of the sub areas each include different content. In an example of a table or system described herein can include the computing device including a transfer module, the transfer module transferring subareas between different user areas based on a touch in a source subarea of the display. In an example of a table or system described herein can include the display being virtually divided into user areas, wherein an input placed into a first user areas is associated with a first user, and an input placed into a second user area is associated with a second user. In an example of a table or system described herein can include inputs into a first user area and inputs into a second user area can be received substantially concurrently. In an example of a table or system described herein can include the touch sensitive display including a module that identifies a common shape produced by an object physically placed on the table top display, the computing system determining if a display item is within the common shape and moving the display item to a position outside the shape when the object is positioned on the table top display. In an example of a table or system described herein can include a credit card reader, the credit card reader associated with the housing of the table top.

In an example, a computer system for displaying information on a substantially horizontal Multi-User Interaction Table including a touch-screen display comprises: a processor; a memory device communicatively coupled to the processor, the touch-screen display also communicatively coupled to the memory and processor; a display division module for dividing a display into at least a first user defined area and a second user defined area; a first association module for associating inputs from a first user area with a first user and for associating content and information selected for display by the first user with the first user; a second association module for associating inputs from a second user area with a second user and for associating content and information selected for display by the second user with the second user; wherein at least some of the information and content in at least one of the first or second user areas relates to menu items. In an example of a table or system described herein can include the display division module dividing the display into a first user area and a second user area based on input from at least the first user. In an example of a table or system described herein can include a module for subdividing a user area into subareas, the computer system displaying information and content associated with a user in the subareas, wherein at least one of the subareas includes an interface to an application for presenting a menu options for at least a first user. In an example of a table or system described herein can include an object detection module for detecting an object on the touch screen display and determining if a subarea carrying content is located below the object; and a subarea movement module for moving subarea below the object to a portion of the first user area viewable by the first user. In an example of a table or system described herein can include a bill paying module located at the Multi-User Social-Interaction Table. In an example of a table or system described herein can include a content moving module for moving content from a subarea in the first user area to a second user area in response to an input stroke starting in the first user area and ending in the second user area. In an example of a table or system described herein can include a content moving module for moving content from a subarea in the first user area to a second user area in response to an input stroke at an icon for moving content from the first user area to the second user area.

The present disclosure further includes methods that may operate using the structures described herein. In an example, a computerized method for displaying information on a substantially horizontal table including a touch screen display, the method comprises: using a memory device and a processor, providing a portion of a display to a user as a user area; displaying content and information related to the first user in subareas of the first user area; associating inputs from a first user area with a first user; displaying content and information related to the second user in a second user area; associating inputs from a second user area with a second user, wherein the information and content in at least one of the subareas relates to menu items to allow selecting of menu items using the display as an input device to an ordering system. In an example, a method as described herein can include communicatively coupling the memory device and processor associated with the display to an internet connection, wherein displaying content and information related to the first user includes internet applications. In an example, a method as described herein can include detecting an object on the display; determining if a subarea carrying content is located below the object; and moving the content of a subarea below the object to another subarea outside the area below the object. In an example, a method as described herein can include detecting an object on the display; determining if a subarea carrying content is located below the object; and resizing the subareas on the display within the first user area to move the content of a subarea below the object to a position where the first user is able to view the subareas. In an example, a method as described herein can include moving content from a subarea in the first user area to a second user area in response to an input stroke starting in the first user area and ending in the second user area. In an example, a method as described herein can include detecting an object on the display and triggering a timing event in response to detecting an object on a display in a selected area of the display. In an example, a method as described herein can include detecting a selected movement of an object on the display and triggering an event in response to detecting the selected movement. In an example, a method as described herein can include triggering the event in response to detecting the selected movement and including events remote from the display. In an example, a method as described herein can include tracking at least one of the first user's inputs or the second user's inputs for analysis. In an example, a method as described herein can include monitoring at least one of the first user's inputs or the second user's inputs; and changing non-sub area content in response to the monitoring.

The present disclosure further includes methods that may operate using the structures described herein. In an example, a computerized method comprising determining an amount of time a user spends reviewing content and associating a touch of the display to the content. In an example, a method as described herein can include the content being promotional material. In an example, a method as described herein can include the content being educational material.

Although a few variations have been described and illustrated in detail above, it should be understood that other modifications are possible. In addition it should be understood that the logic flow depicted in the accompanying figures and described herein do not require the particular order shown, or sequential order, to achieve desirable results. Other embodiments may be within the scope of the following claims.

What is claimed is:

1. A table system, comprising:
a substantially horizontal table top to be supported at a level above the ground, the table top including a substantially horizontally extending display, which is touch sensitive, the table top having a thickness less than or equal to twelve inches;
a computing device in communication with the display to receive touch signals, the computing device to define multiple user areas on the display, the multiple user areas being oriented to users seated at the table top;
wherein the table top is to receive multiple touches on the display essentially concurrently;
wherein the multiple touches are determined to provide distinct control signals to the computing device to control operation of the computing device; and
wherein the users at the table top can individually select menu items through respective user areas.

2. The table system of claim 1, wherein the substantially horizontal table top further comprises a housing, the display substantially within the housing, which protects the display from environmental damage.

3. The table system of claim 1, wherein the computing device is contained substantially within the table top.

4. The table system of claim 1 further comprising an output device in communication with the computing device.

5. The table system of claim 2 further comprising a printer, the printer associated within the housing of the table top.

6. The table system of claim 1 wherein the display is a single, unitary display that is virtually dividable into at least two user areas.

7. The table system of claim 6 wherein the display is virtually divided into user areas defined by a plurality of users.

8. The table system of claim 6 wherein at least one user area is divided into a plurality of sub areas, wherein at least two of the sub areas each include different content.

9. The table system of claim 8 wherein the computing device includes a transfer module, the transfer module transferring subareas between different user areas based on a touch in a source subarea of the display.

10. The table system of claim 6 wherein the display is virtually divided into user areas, wherein an input placed into a first user areas is associated with a first user, and an input placed into a second user area is associated with a second user.

11. The table system of claim 10 wherein inputs into a first user area and inputs into a second user area can be received substantially concurrently.

12. The table system of claim 1 wherein the touch sensitive display includes a module that identifies a common shape produced by an object physically placed on the table top display, the computing system determining if a display item is within the common shape and moving the display item to a position outside the shape when the object is positioned on the table top display.

13. The table system of claim 2 further comprising a credit card reader, the credit card reader associated with the housing of the table top.

14. A computer system for displaying information on a substantially horizontal military table including a touch-screen display comprising:
a processor;
a memory device communicatively coupled to the processor, the touch-screen display also communicatively coupled to the memory and processor;
a display division module for dividing a display into at least a first user defined area and a second user defined area;
a first association module for associating inputs from a first user area with a first user and for associating content and information selected for display by the first user with the first user;
a second association module for associating inputs from a second user area with a second user and for associating content and information selected for display by the second user with the second user;
wherein at least some of the information and content in at least one of the first or second user areas relates to menu items.

15. The computer system of claim 14 wherein the display division module divides the display into a first user area and a second user area based on input from at least the first user.

16. The computer system of claim 14 further comprising:
a module for subdividing a user area into subareas, the computer system displaying information and content associated with a user in the subareas, wherein at least one of the subareas includes an interface to an application for presenting a menu options for at least a first user.

17. The computer system of claim 14 further comprising:
an object detection module for detecting an object on the touch screen display and determining if a subarea carrying content is located below the object; and
a subarea movement module for moving subarea below the object to a portion of the first user area viewable by the first user.

18. The computer system of claim 14 further comprising a bill paying module located at the table.

19. The computer system of claim 14 further comprising a content moving module for moving content from a subarea in the first user area to a second user area in response to an input stroke starting in the first user area and ending in the second user area.

20. The computer system of claim 14 further comprising a content moving module for moving content from a subarea in the first user area to a second user area in response to an input stroke at an icon for moving content from the first user area to the second user area.
